(19) United States
(12) Patent Application Publication
(10) Pub. No.: US 2022/0360062 A1
(43) Pub. Date: Nov. 10, 2022

(54) SURFACE-FLUSH ELECTRICAL PLATE APPARATUS AND METHOD OF USE

(71) Applicant: EOMA, Inc., Fire Island Pines, NY (US)

(72) Inventors: Anthony West, Sayville, NY (US); Andrea Petti, Sayville, NY (US)

(21) Appl. No.: 17/738,877

(22) Filed: May 6, 2022

Related U.S. Application Data
(60) Provisional application No. 63/185,073, filed on May 6, 2021.

(51) Int. Cl. H02G 3/14

(52) U.S. Cl. CPC H02G 3/14

(57) ABSTRACT

A flush-mounted cover apparatus is provided for electrical and other components mounted in a structure, such as a wall, floor or ceiling. The cover apparatus includes a main body with a hollow interior receiving the component. The main body includes an outer lip with perforations. A locking mechanism secures the main body in the structure. A fitting system accommodates adjusting the cover apparatus position relative to the structure surface for flush-mounting. An outer plate is mounted on the main body and provides access thereto. A finish guard is configured for mounting on the outer plate.

### CROSS-REFERENCE TO RELATED APPLICATION

This application claims priority in U.S. Provisional Patent Application No. 63/185,073, filed May 6, 2021, which is incorporated herein by reference.

### BACKGROUND OF THE INVENTION

### 1. Field of the Invention

The present invention relates generally to electrical cover and plate assemblies and methods for use thereof, and more specifically, to surface-flush electrical plate apparatuses for hosting electronic devices, electrical components, and electrical box openings mounted within the apparatus. The present invention is particularly directed to surface electrical plate apparatuses which ensure hosted electronic devices, electrical components, and/or smart home Internet of Things (IoT) devices are flush with adjacent surfaces, without protrusion from and fitting uniformly against the surrounding surfaces, while maintaining convenient and efficient user access to electrical components on hosted devices or components to accommodate maintenance needs.

### 2. Description of the Related Art

Electrical covers and plates are commonplace in all types of finished buildings to allow people to operate various electrical systems and objects, including but not limited to electrical switches and electrical outlets, while protecting users from electrocution or other injury as well as protecting electrical components themselves. However, standard electrical covers and plates are generally visually unattractive and protrude from the surface they are mounted on. Such standard electrical covers and plates tend to stand out against adjacent architectural structures, such as drywall, tile, stone, wood trim, etc. Particularly for spaces with modern architectural design, electrical covers and plates can be an eyesore or, at a minimum, a missed design opportunity. What is needed is an electrical cover apparatus with an aesthetically pleasing yet functional design.

While there are some electrical covers and plates available which are configured for being flush with the surface they are applied to, they have many disadvantages. These flush electrical covers and plates are expensive, difficult to install, and difficult to access the electrical components within after installation for maintenance. Additionally, these other flush electrical covers and plates do not fit with industry standard electrical receiver boxes. What is desired is a functional, efficient retrofitting electrical cover system with a sleek, modern design.

In recent years, smart home Internet of Things (IoT) devices have become very popular with consumers. Such smart home IoT devices include, but are not limited to, smart thermostats, electrical switches, smoke detectors, carbon monoxide detectors, alarm systems, doorbells, cameras, motion detectors, and speakers. Similar to conventional electrical covers and plates, conventional wall mounts, plates, and covers for smart home IoT devices are generally visually unattractive and result in the devices protruding from the mounted surface. What is desired is an electrical mounting and/or cover system for smart home IoT devices with a sleek, modern design.

Heretofore there has not been available an electrical cover apparatus or method with the advantages and features of the present invention.

### SUMMARY OF THE INVENTION

The present invention covers an innovative electrical cover apparatus configured for universally retrofitting conventional electrical components with a sleek, flush to mounted surface installation that results in the electrical cover becoming a part of the overall architectural design rather than a design obstruction. The electrical cover apparatus includes a series of customizable features for use with various electrical components and for use with various adjacent architectural surfaces. The apparatus is further configured for easy installation and convenient and efficient user access to electrical components, as necessary. In aspects of the present invention, the electrical cover apparatus is configured for installation onto different surface materials, including but not limited to drywall, wood, stone, and tile, without changing conventional and standard construction processes and methods thereof.

The electrical cover apparatus includes a main body configured for housing and retrofitting most standard modern electrical switches, outlets, receptacles, smart switches, and other related accessories for installation onto standard universal wall plate openings. In further embodiments, electrical cover apparatuses of the present invention are configured for a mounting, housing, and/or covering all or a portion of smart home Internet of Things (IoT) devices.

The cover apparatus includes a main body having a substantially hollow interior; a series of connection holes, notches, and grooves; a locking mechanism, and an outer lip. The substantially hollow interior is configured for housing electrical components and for accommodating retrofitting of the cover apparatus to conventional electric switches, outlets receptacles, smart switches, and many other related accessories installed onto a universal wall plate opening. In an aspect of the present invention, the cover apparatus is configured to accommodate the highest level of heat dispersion common with most hosted electrical components and devices, such as but not limited to dimmers and smart IoT devices.

The main body outer lip is configured for laying over an adjacent application surface with the cover apparatus in an assembled position and for drywall finishing compound, plaster, spackle, or alternative binding material to be applied over it for flush attachment of the cover apparatus to the application surface.

In an aspect of the present invention, the main body locking mechanism is configured for locking the cover apparatus to the back side of the application surface, such as drywall. The locking mechanism can be toggled between an unlocked position and a locked position by a user reaching through the main body substantially hollow interior to the back of the main body and the back side of the application surface. The locking mechanism is configured to hold the electrical cover apparatus in place in relation to the application surface.

In another aspect of the present invention, the main body includes a fitting system with multiple groove positions. The fitting system accommodates adjustment and adaptation of the cover apparatus to a desired level to which the electrical components or product hosted is set and secured onto the main body. This fitting system allows for a secure fit and ensures a final flushed result. The electrical cover apparatus is configured with a series of spacers and outer finishing plates for use with various electric components and devices to provide universal compatibility with various electrical switches, electrical outlet components and IoT smart devices.

The electrical cover apparatus further includes an access system for convenient and efficient access to the electrical components housed within the apparatus. The outer plate includes a perimetral groove configured for easy removal of the plate to perform all electrical connections or settings of the specific product hosted by the apparatus.

### BRIEF DESCRIPTION OF THE DRAWINGS

The drawings constitute a part of this specification and include exemplary embodiments of the present invention illustrating various objects and features thereof.

FIGS. 1-56 show various views of multiple embodiments of surface-flush electrical plate apparatuses of the present invention.

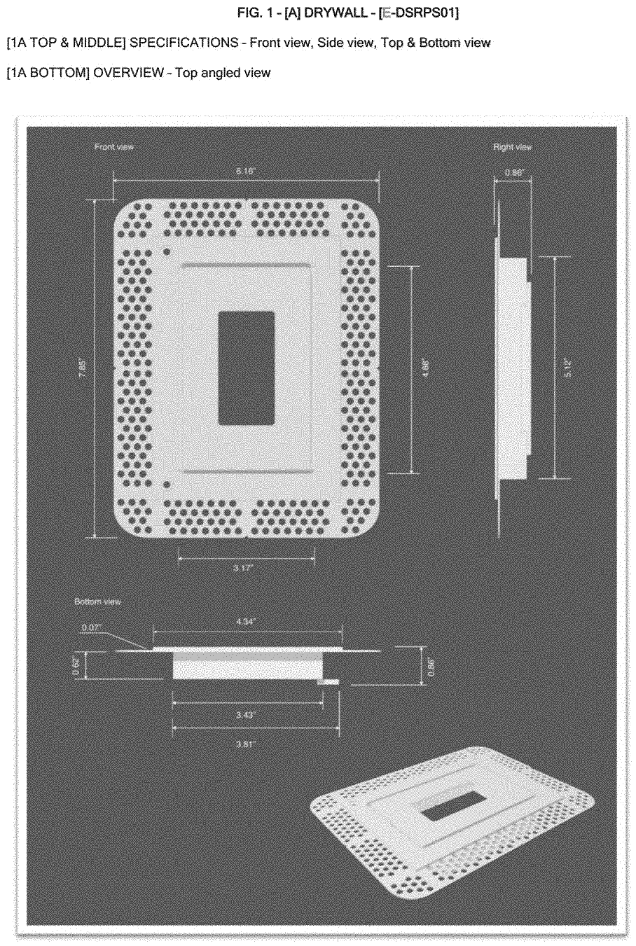

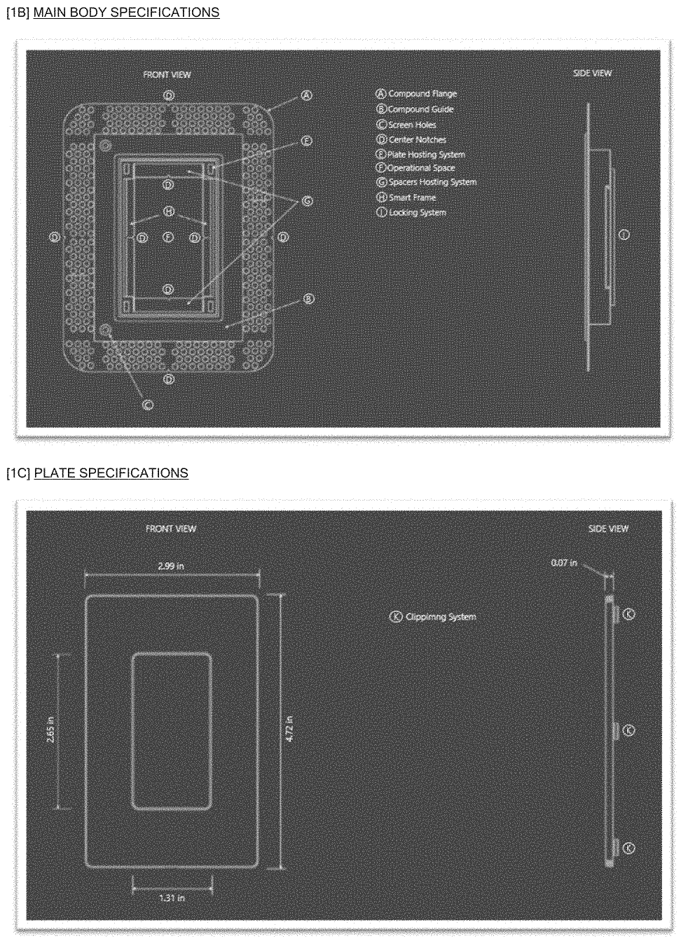

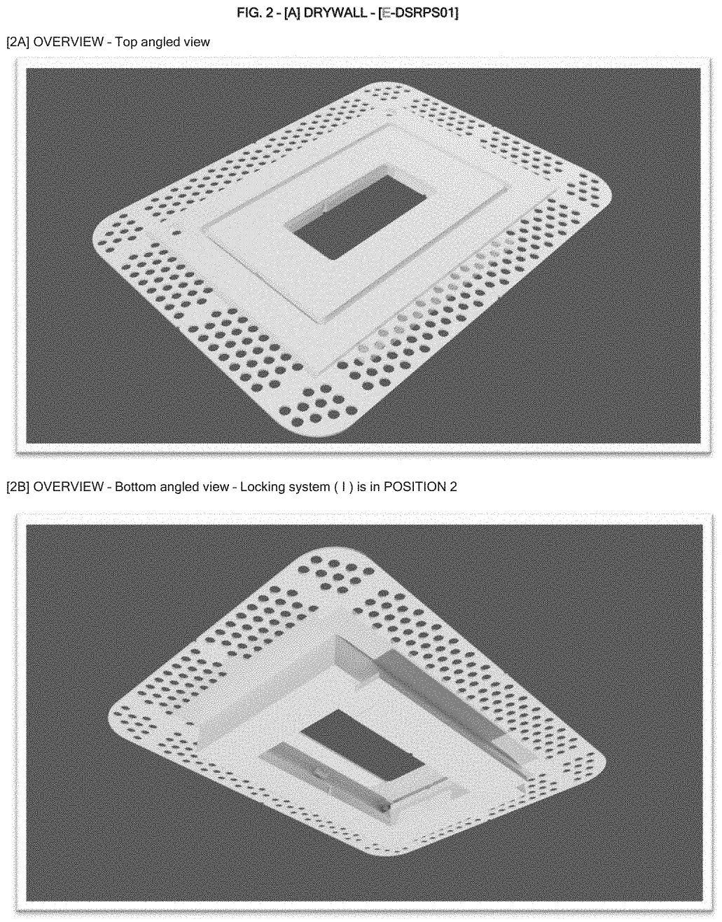

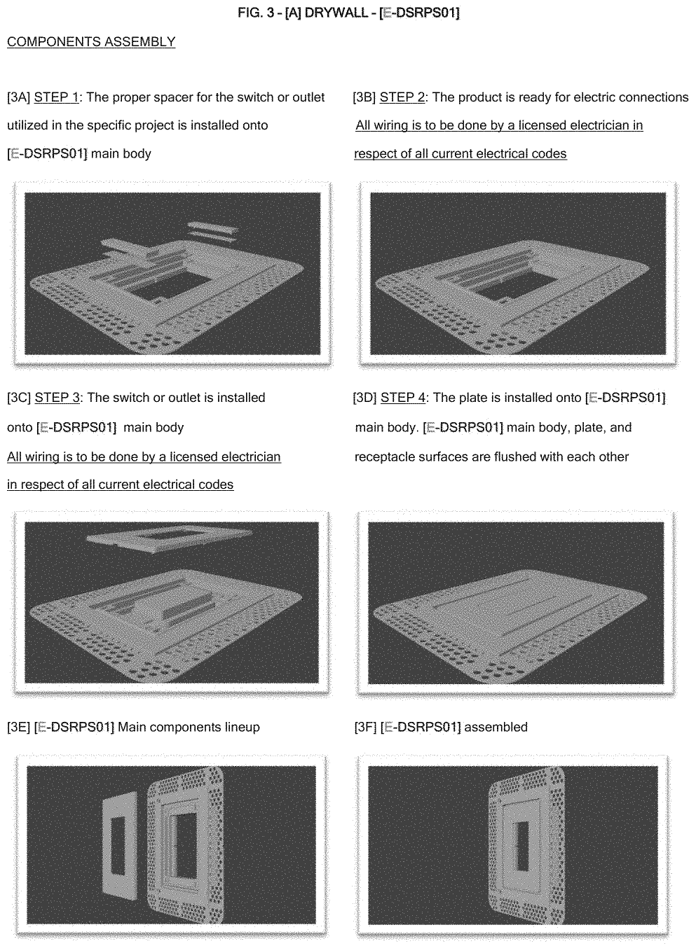

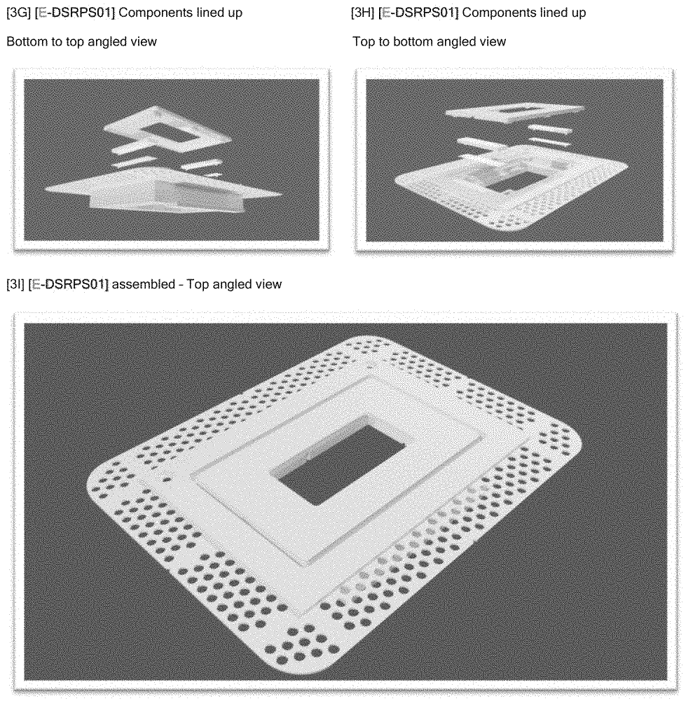

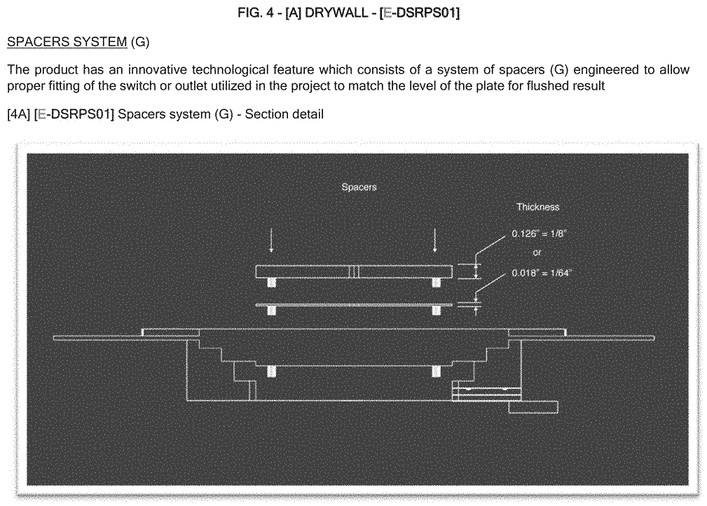

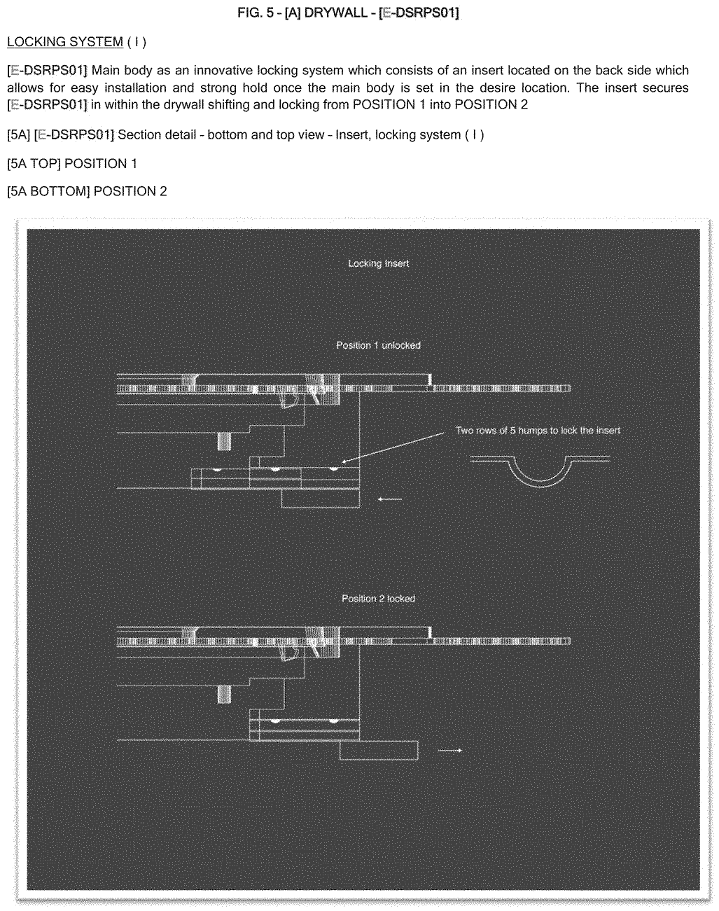

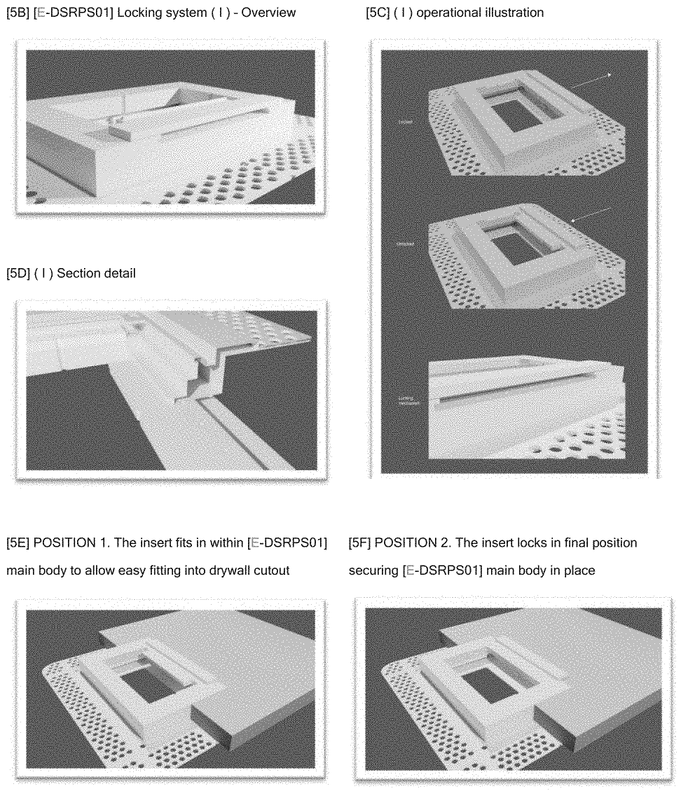

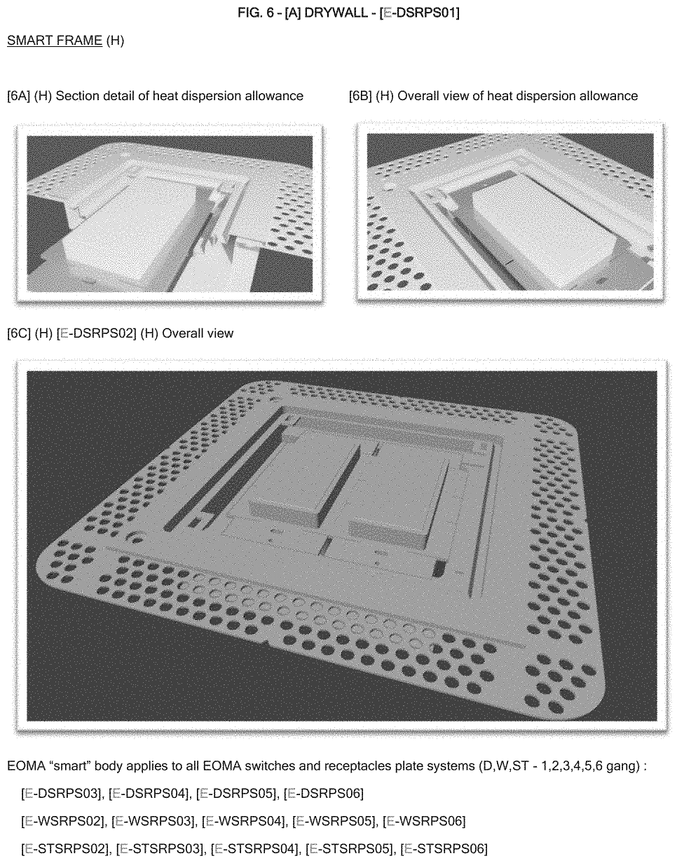

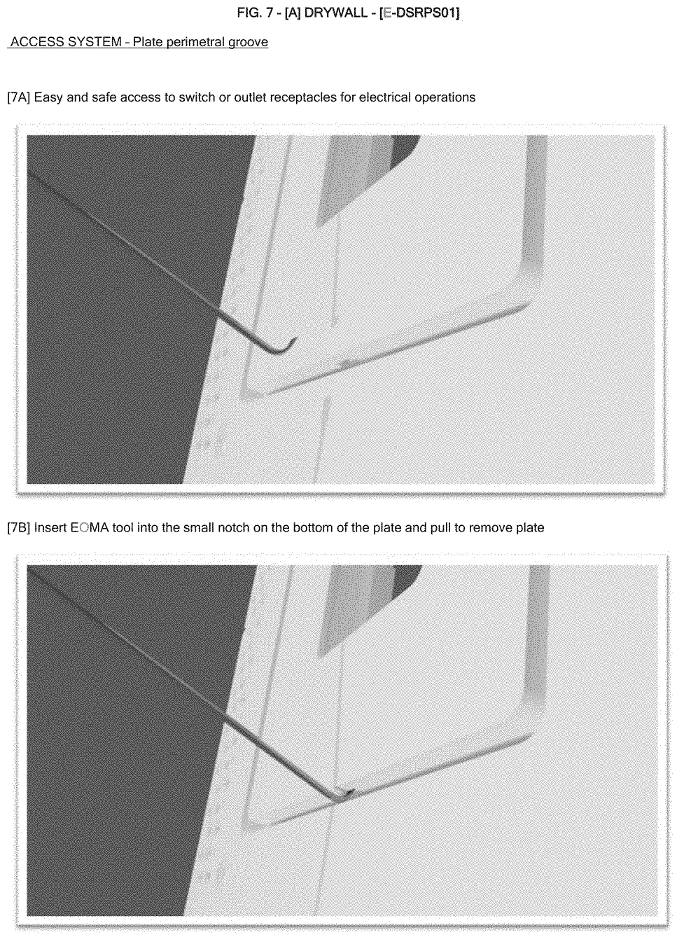

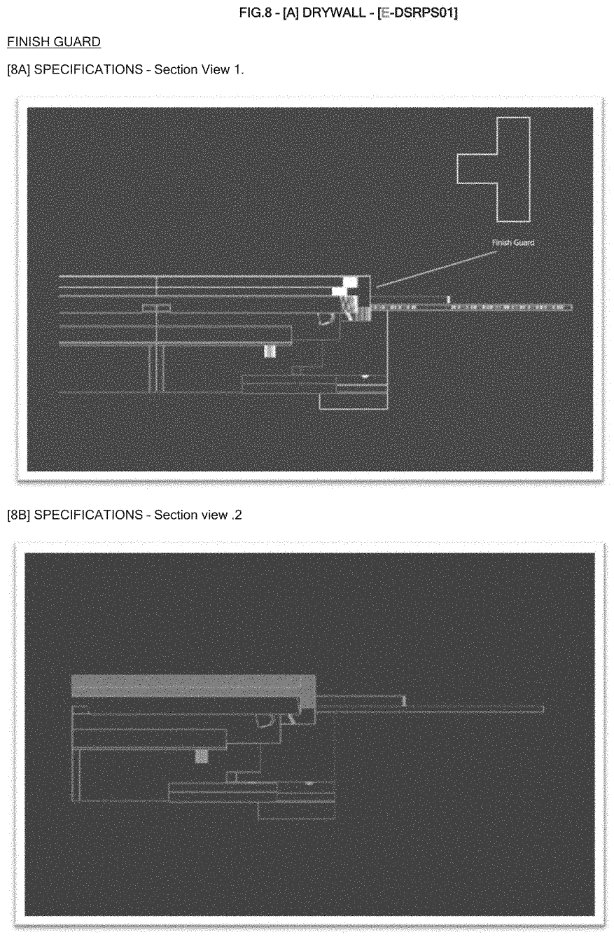

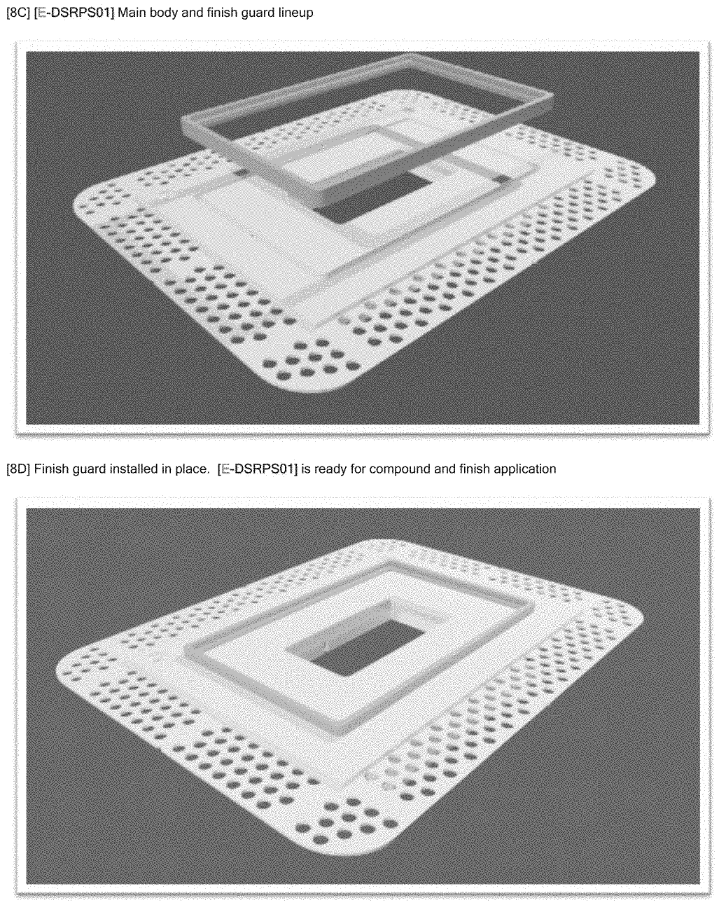

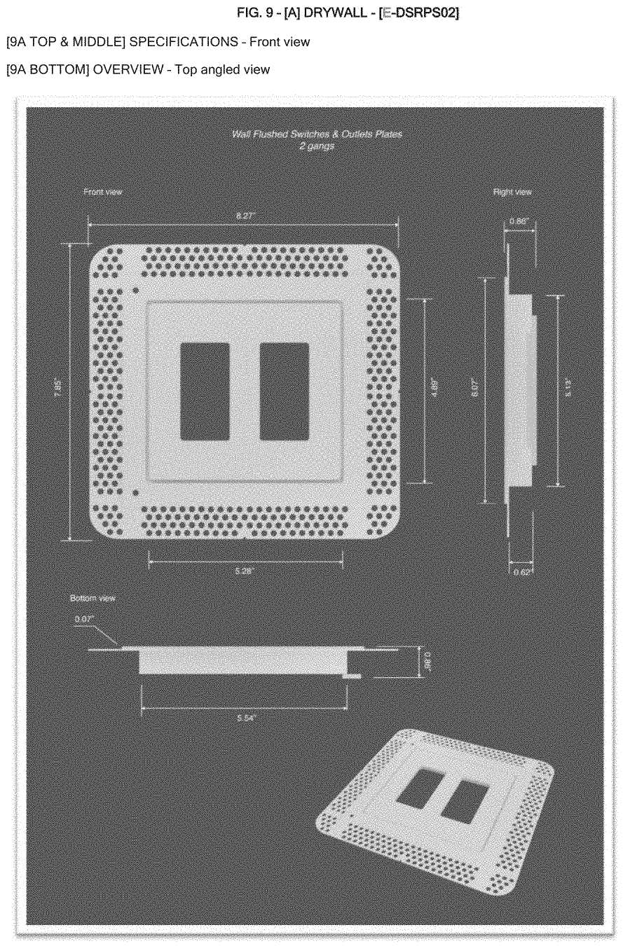

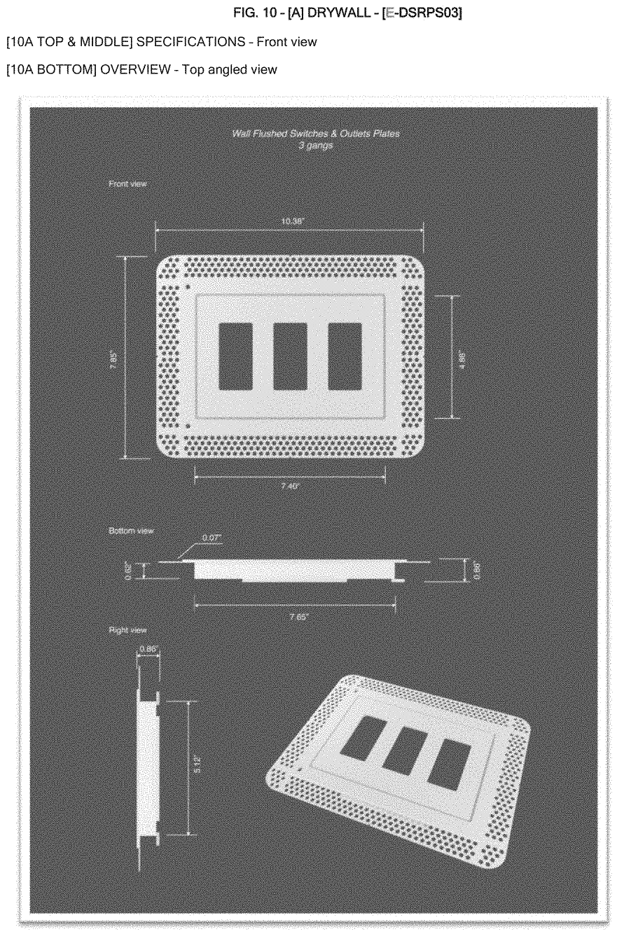

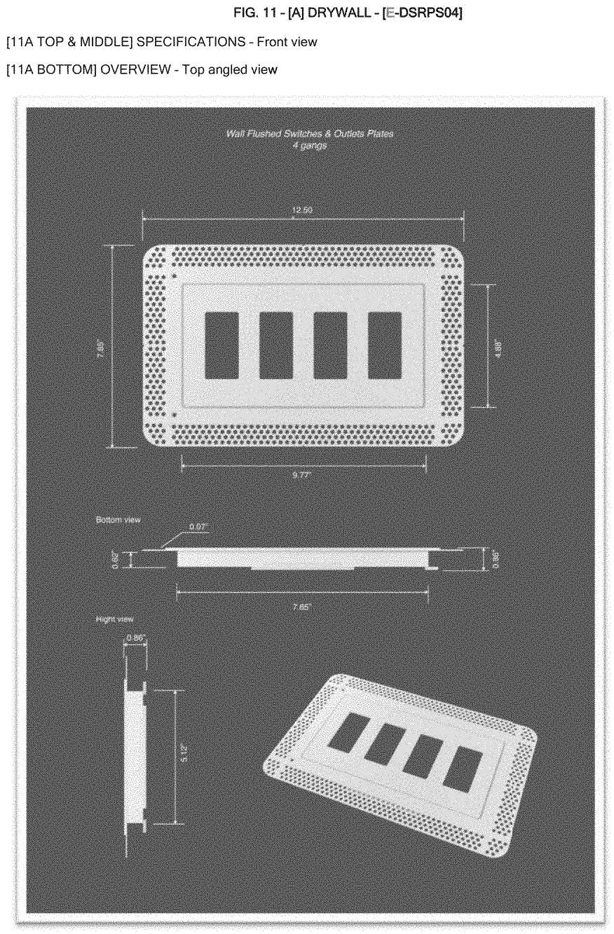

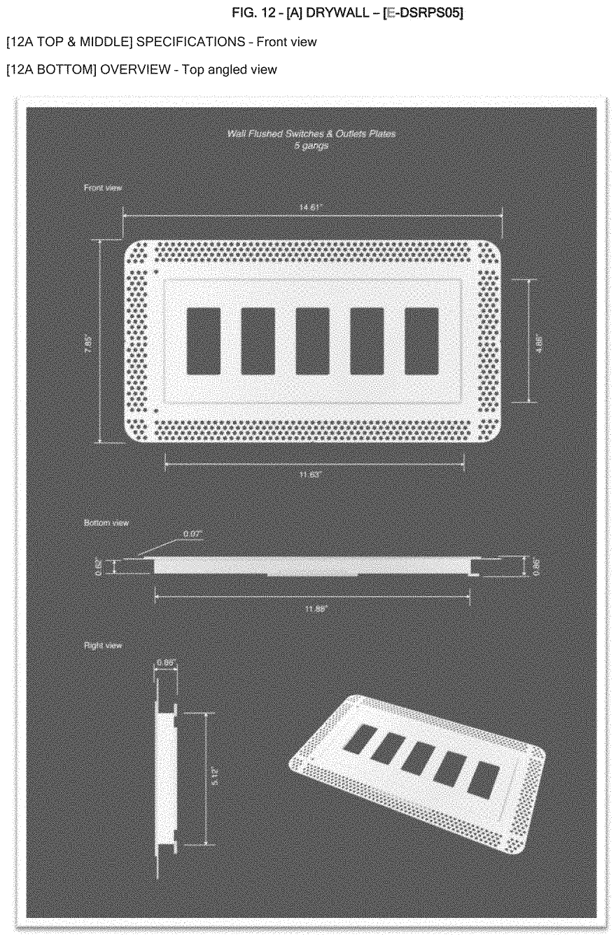

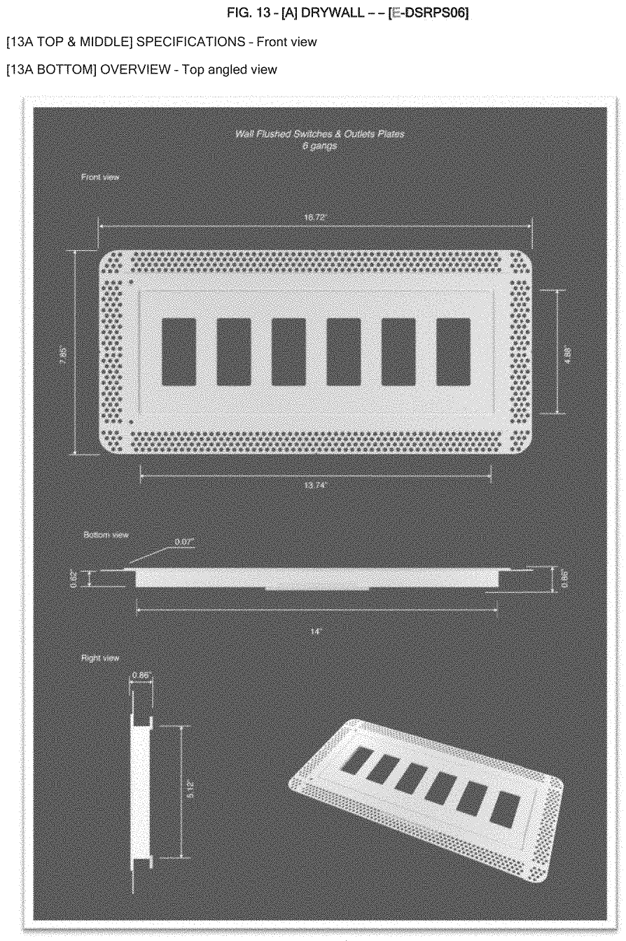

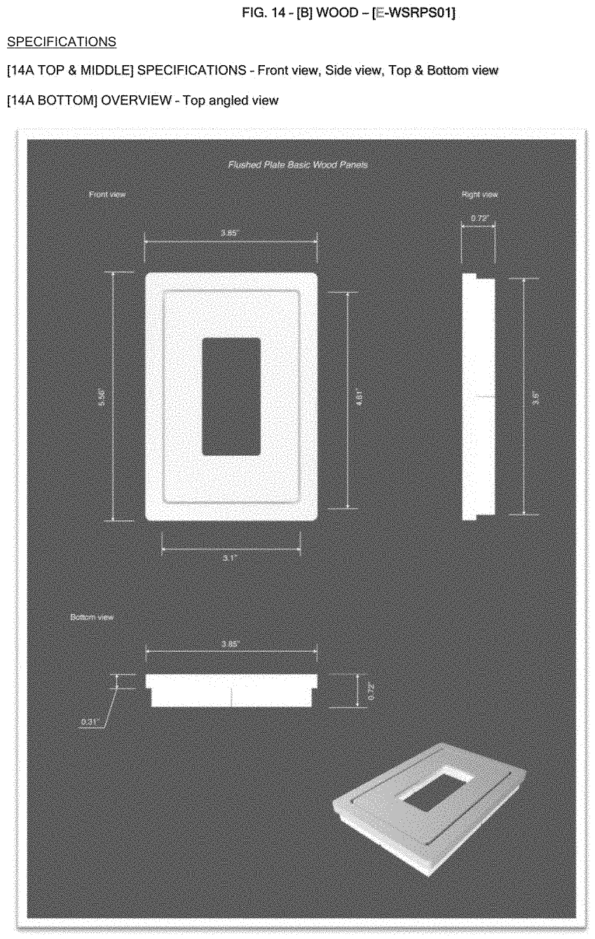

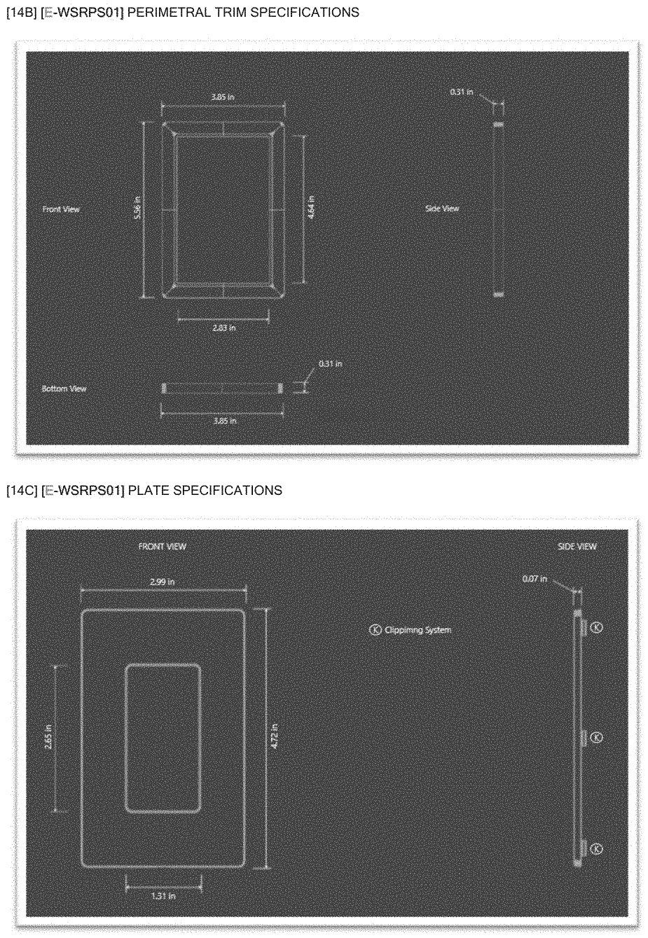

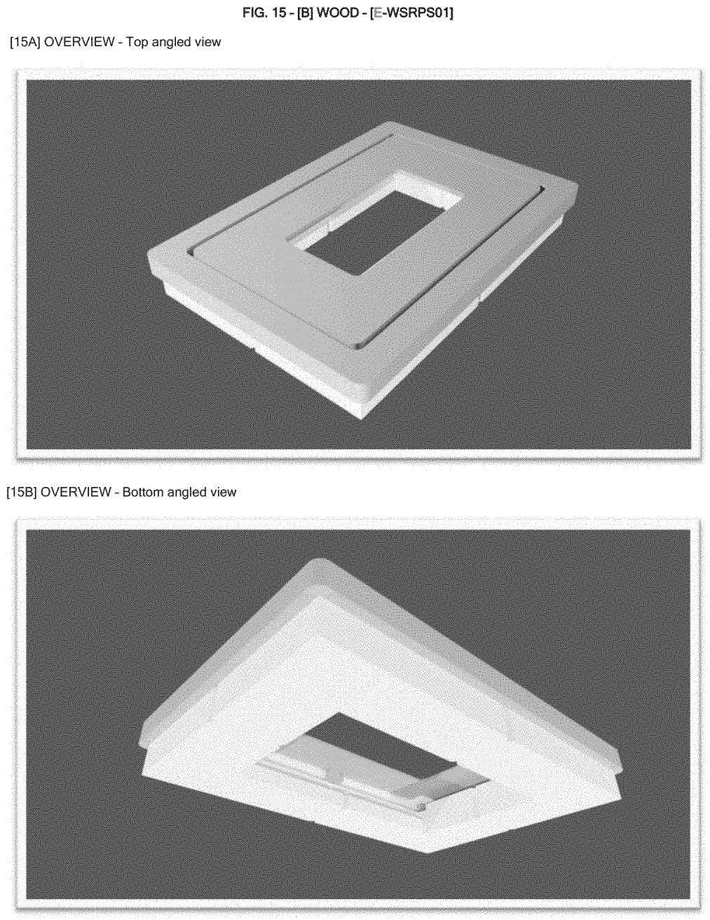

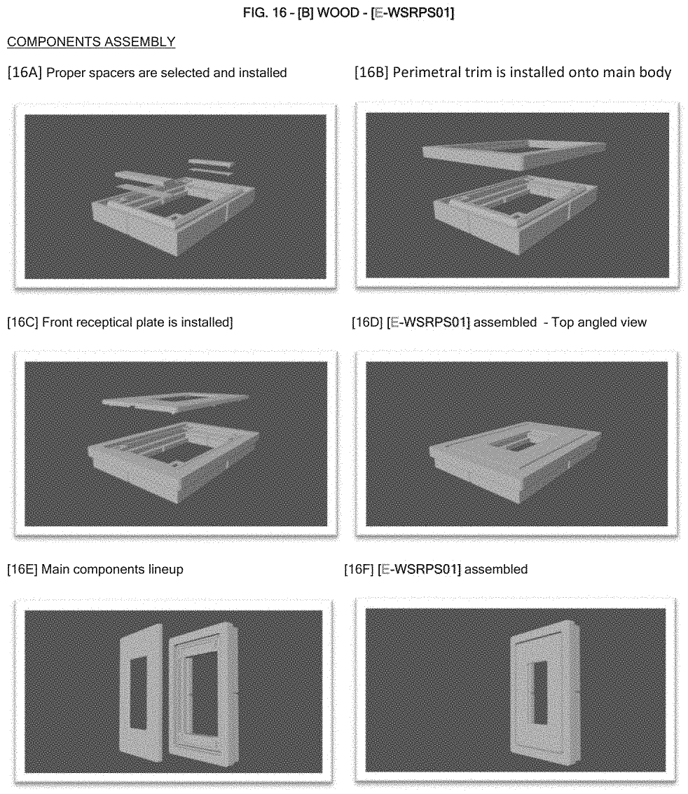

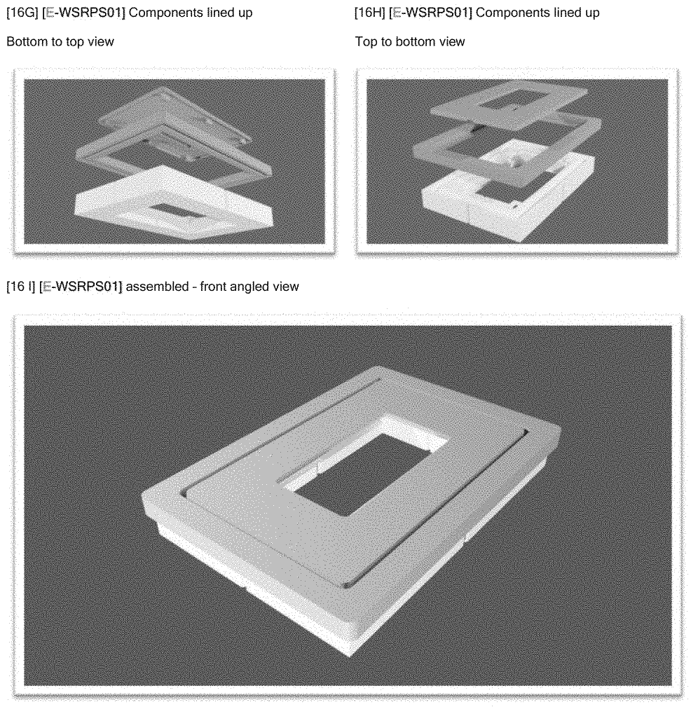

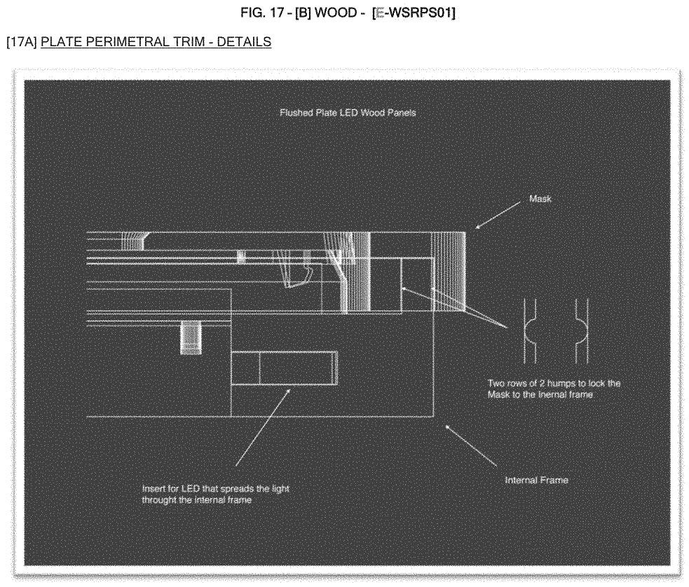

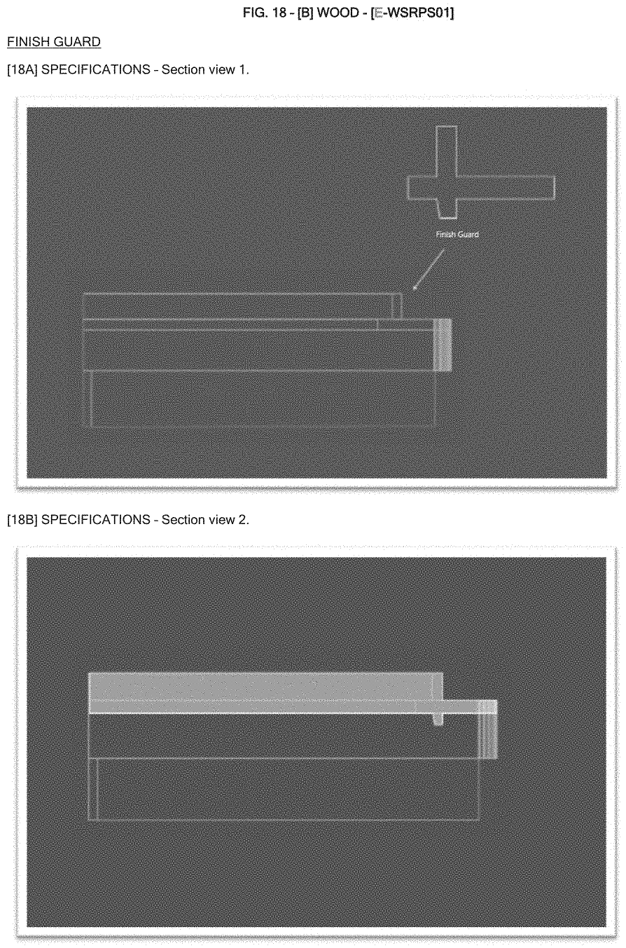

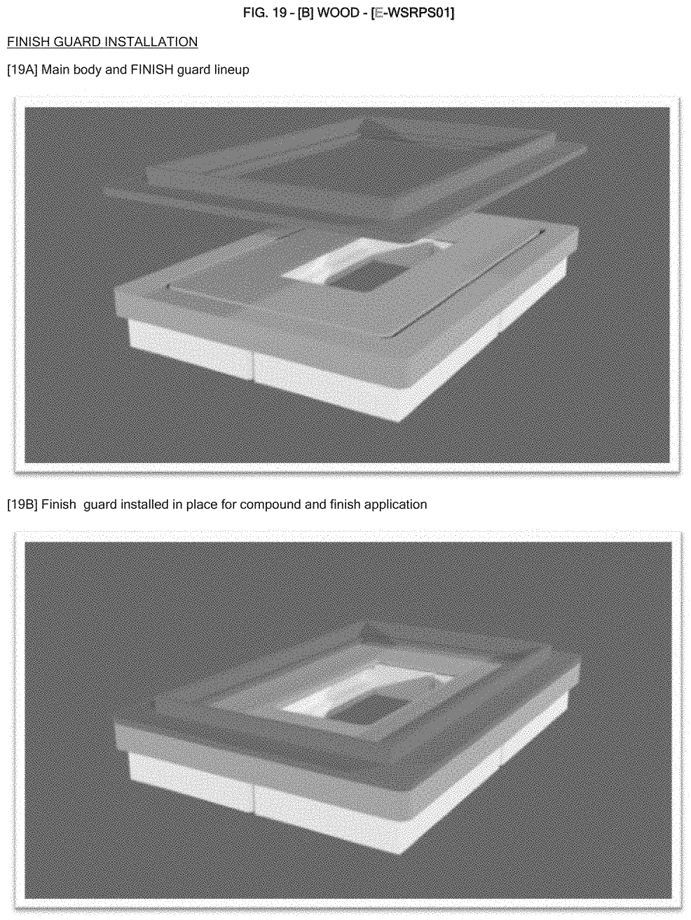

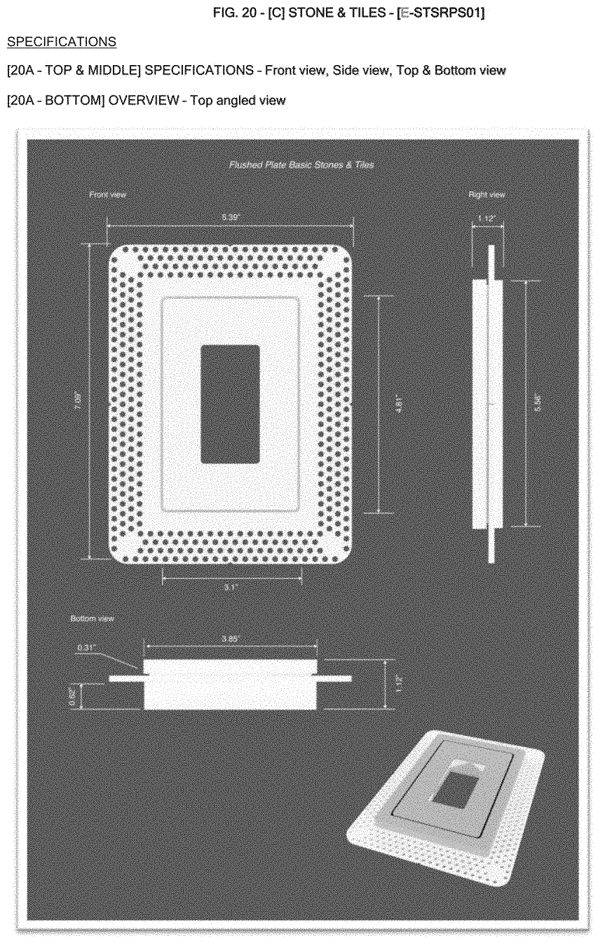

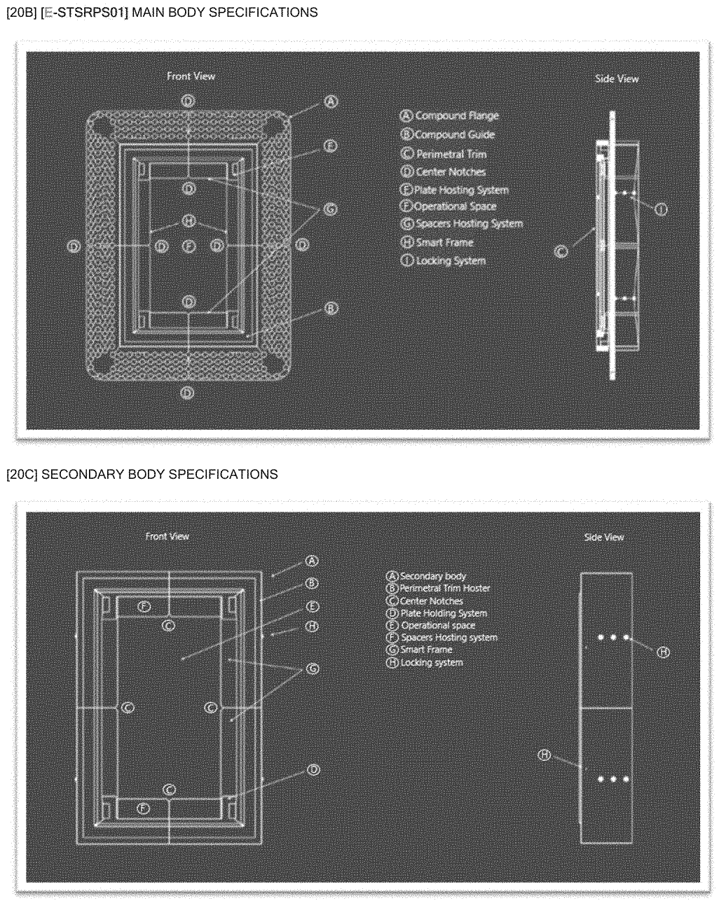

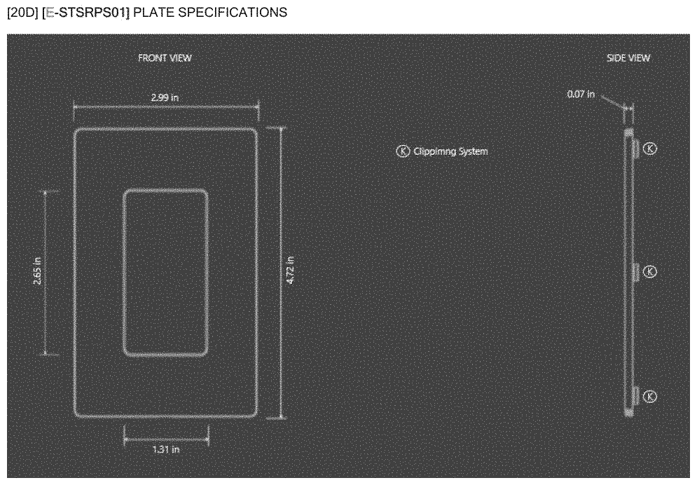

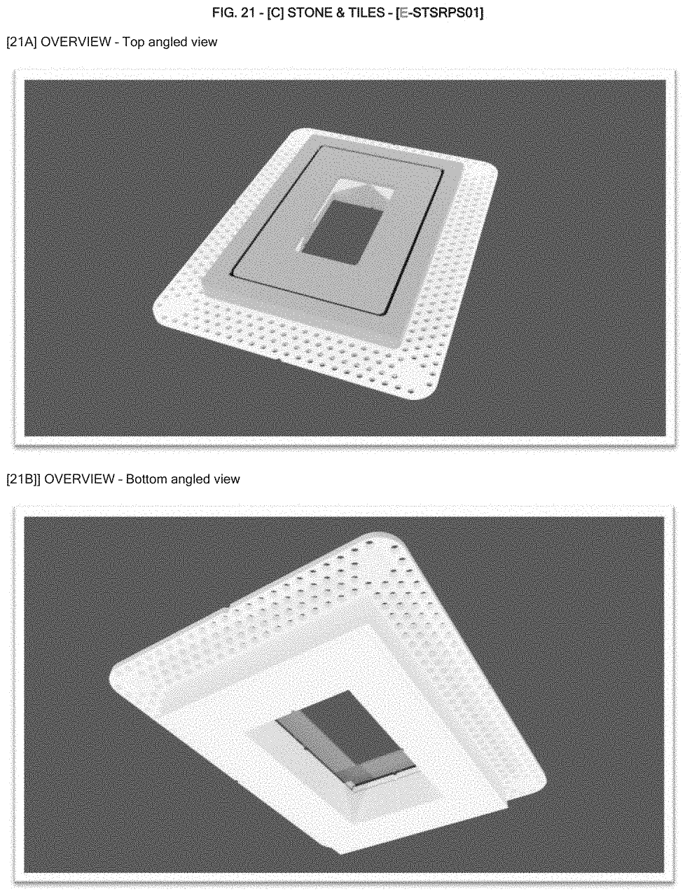

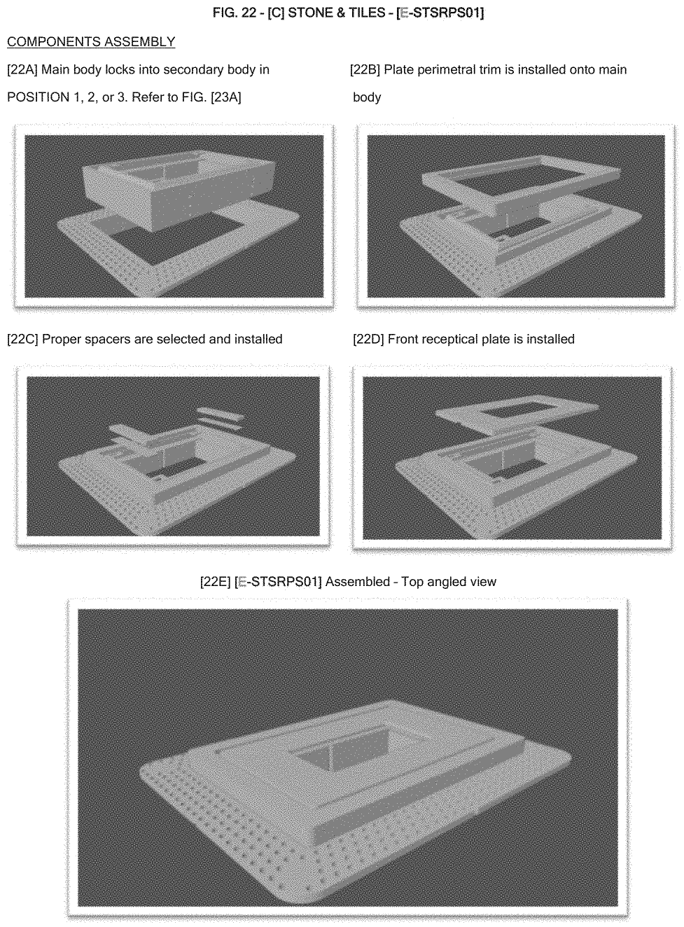

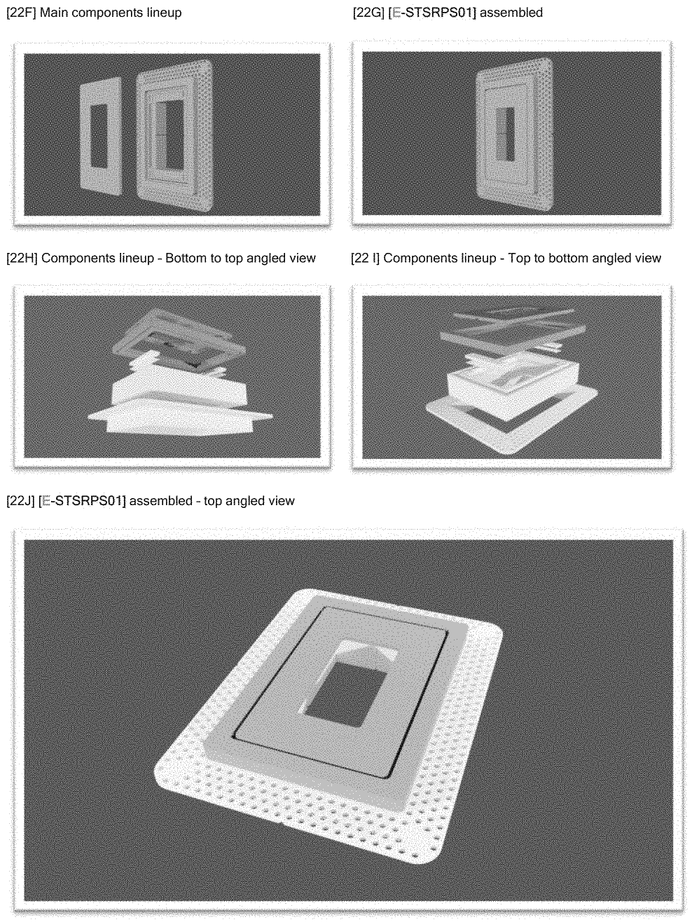

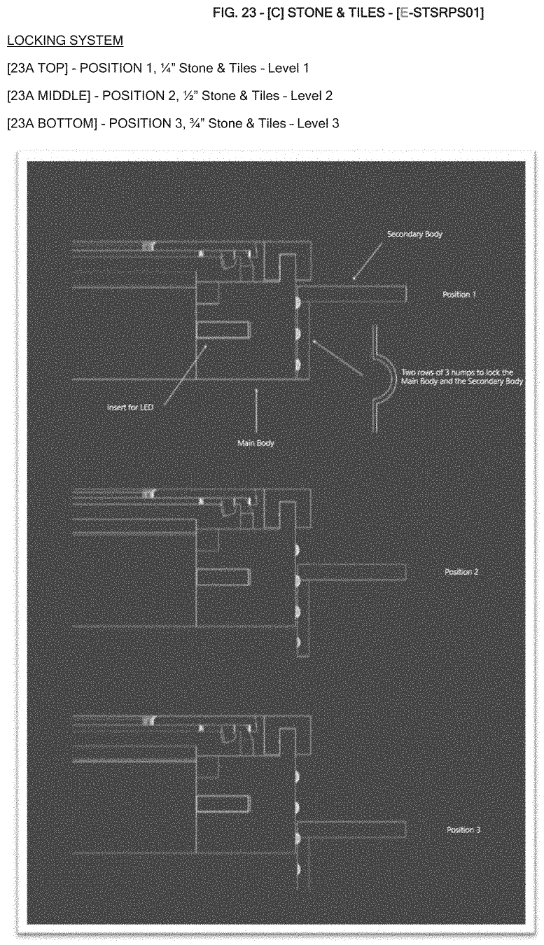

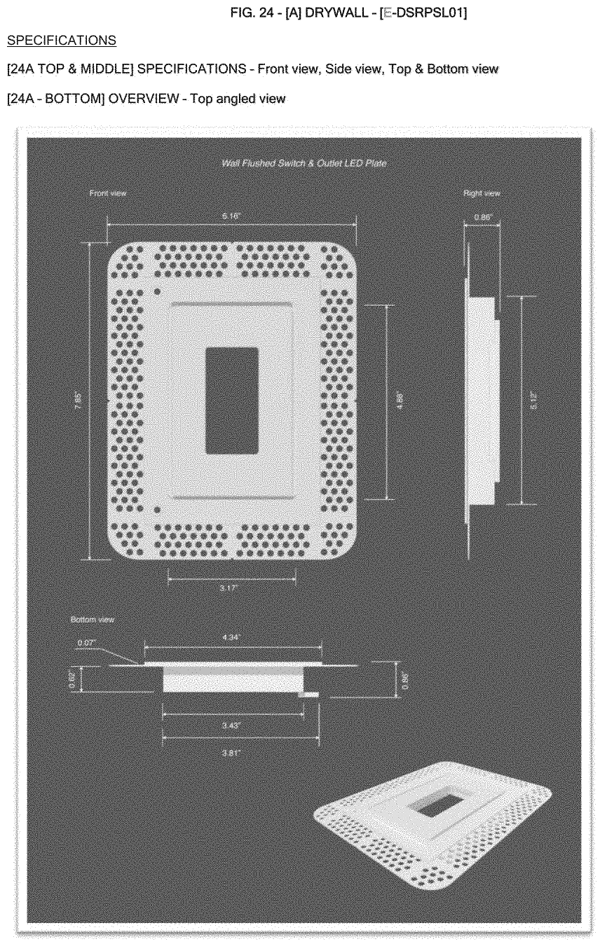

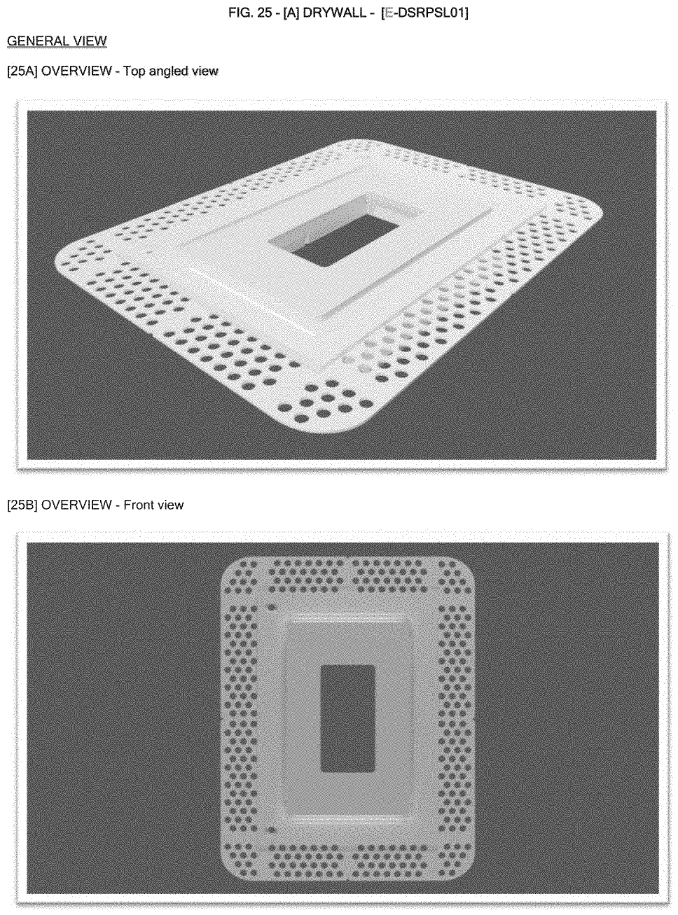

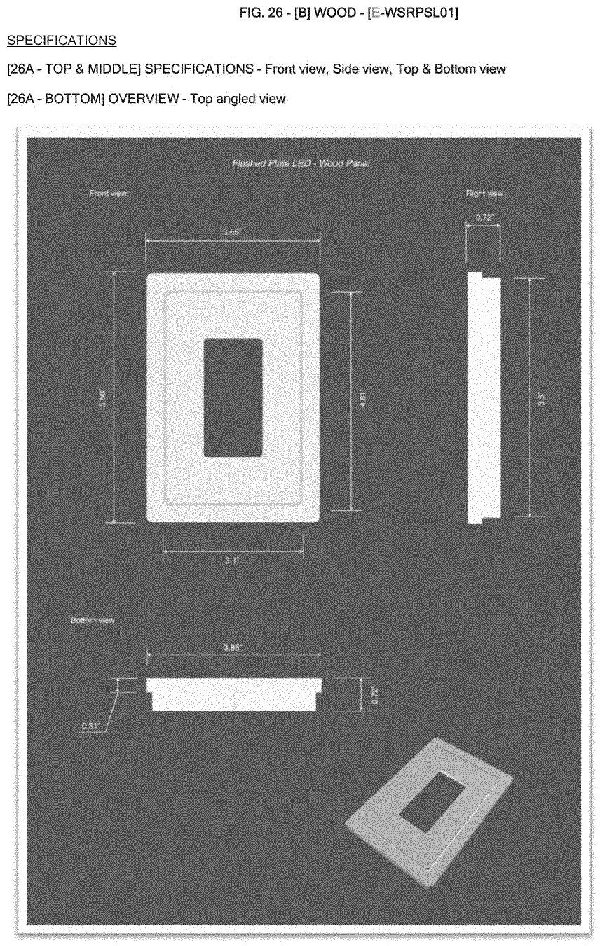

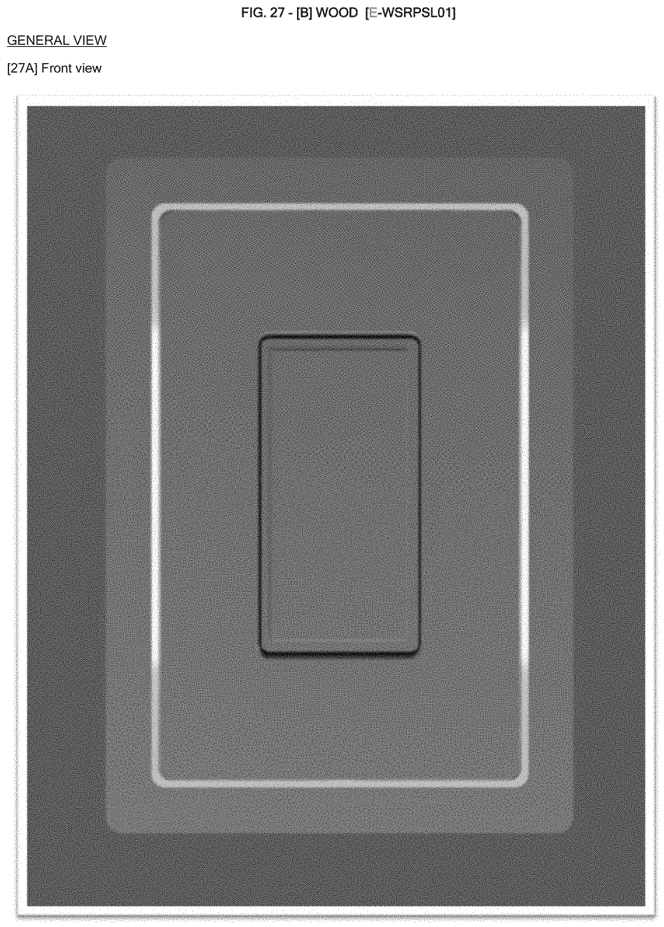

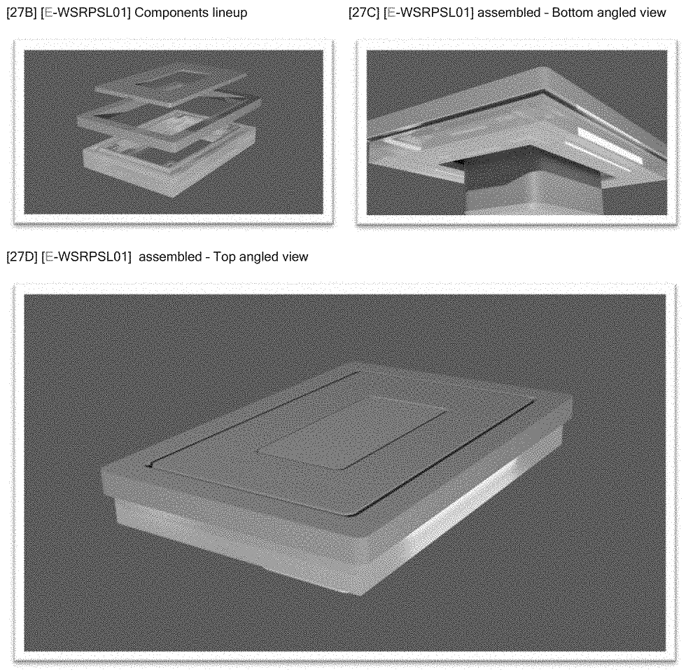

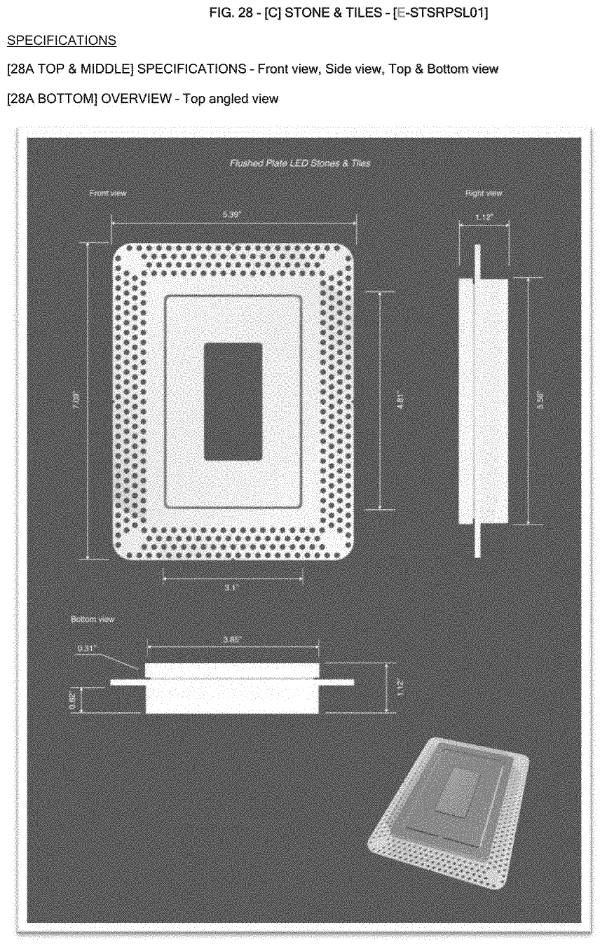

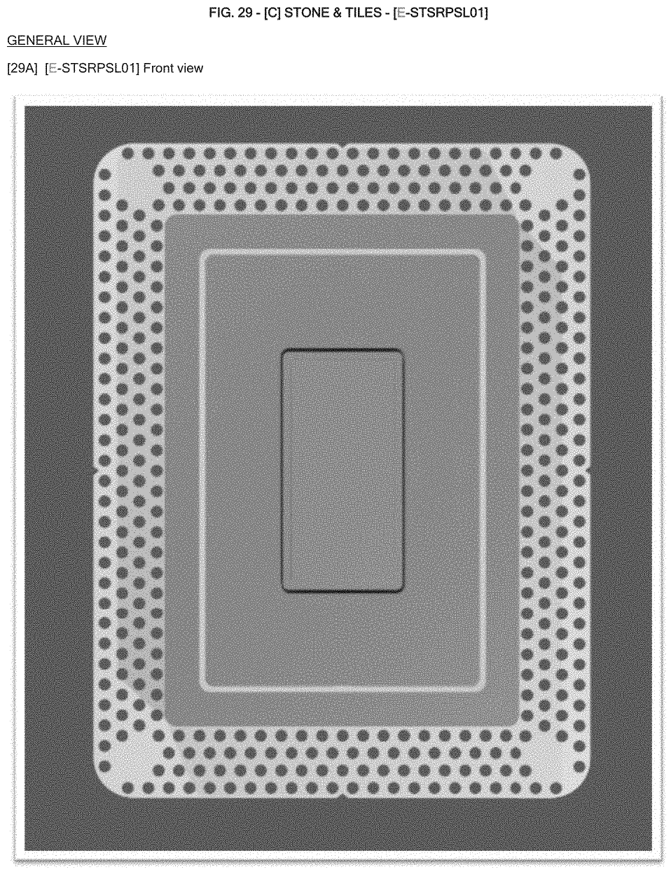

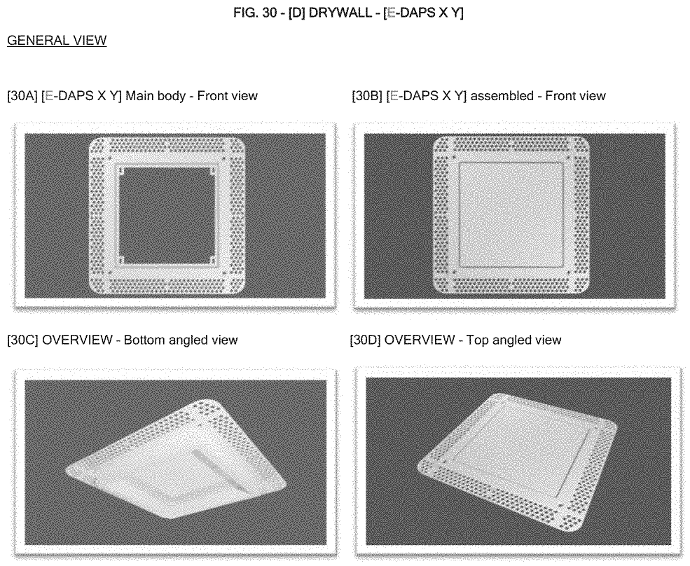

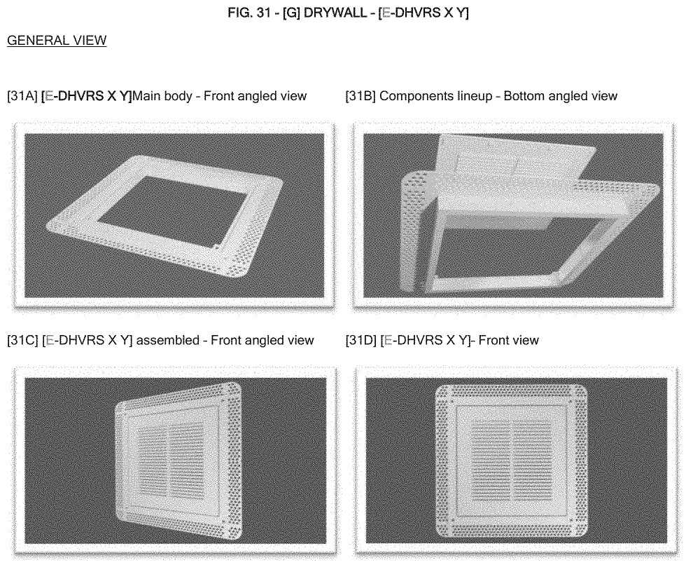

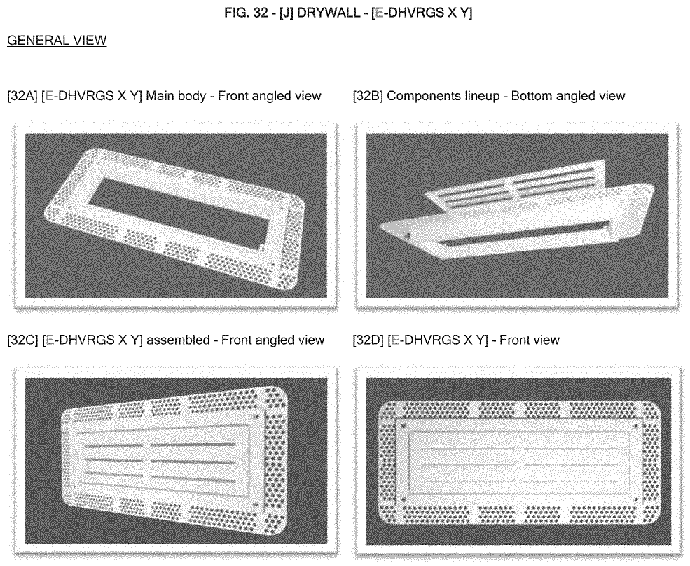

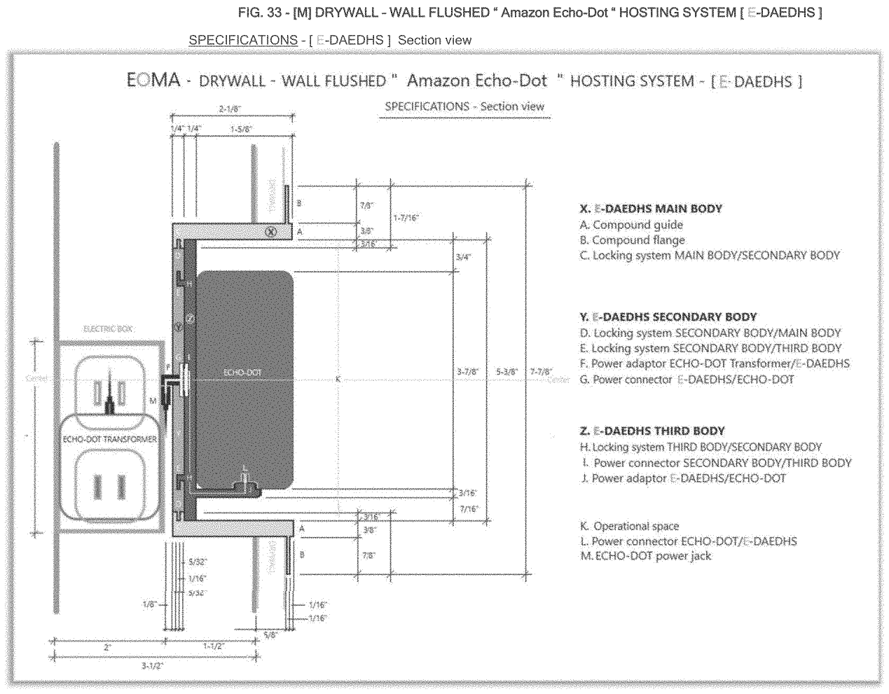

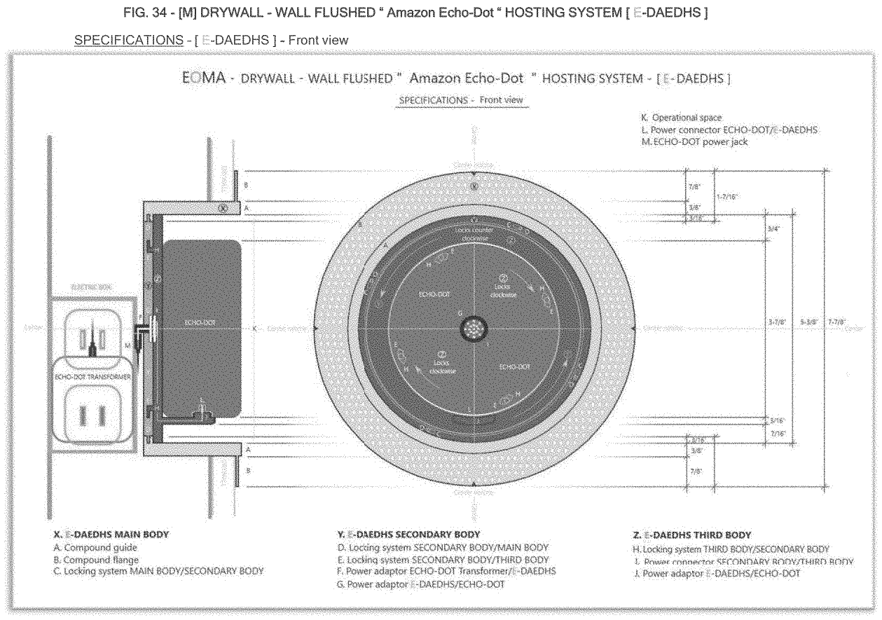

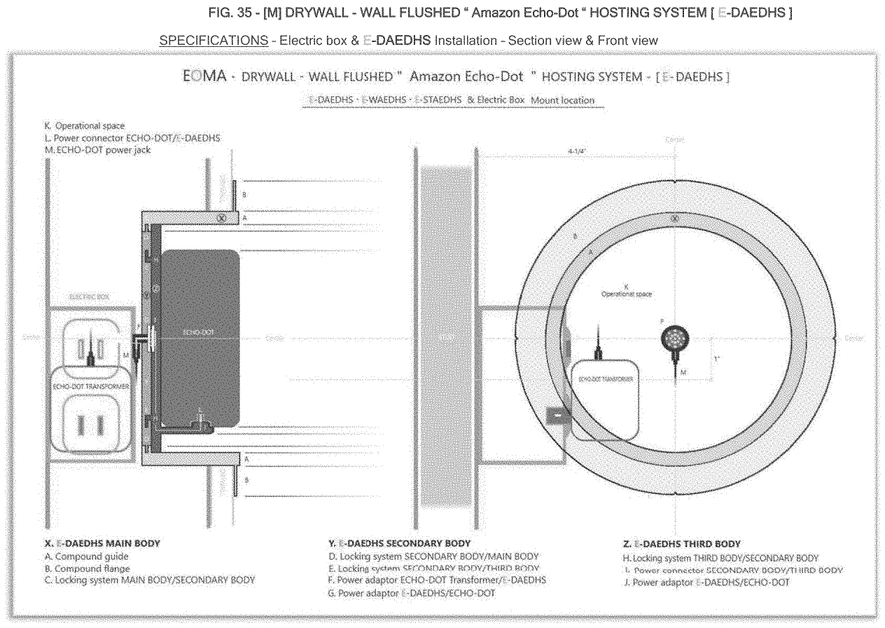

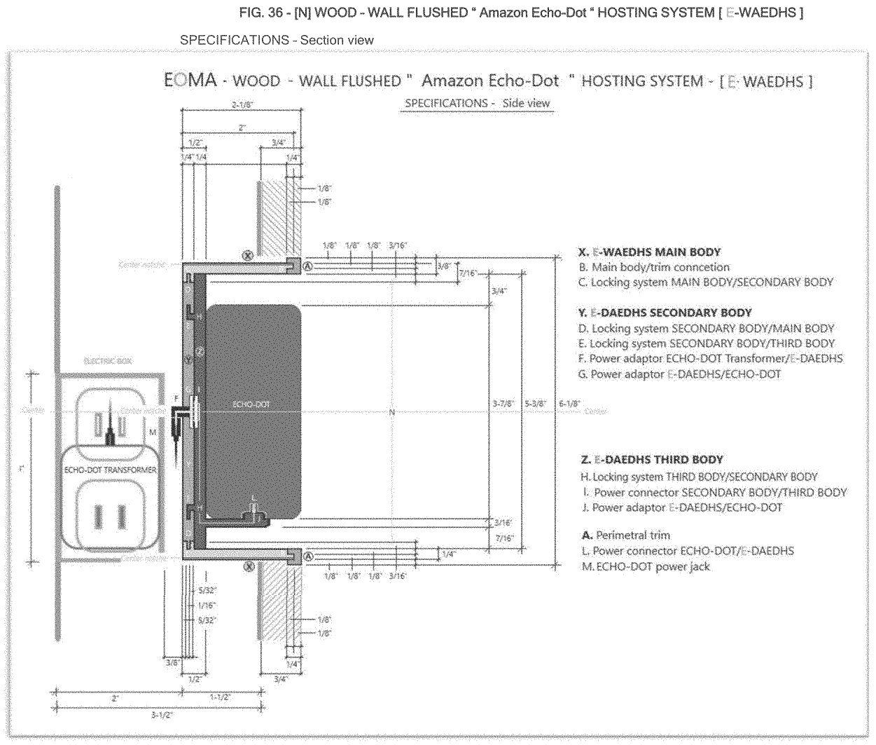

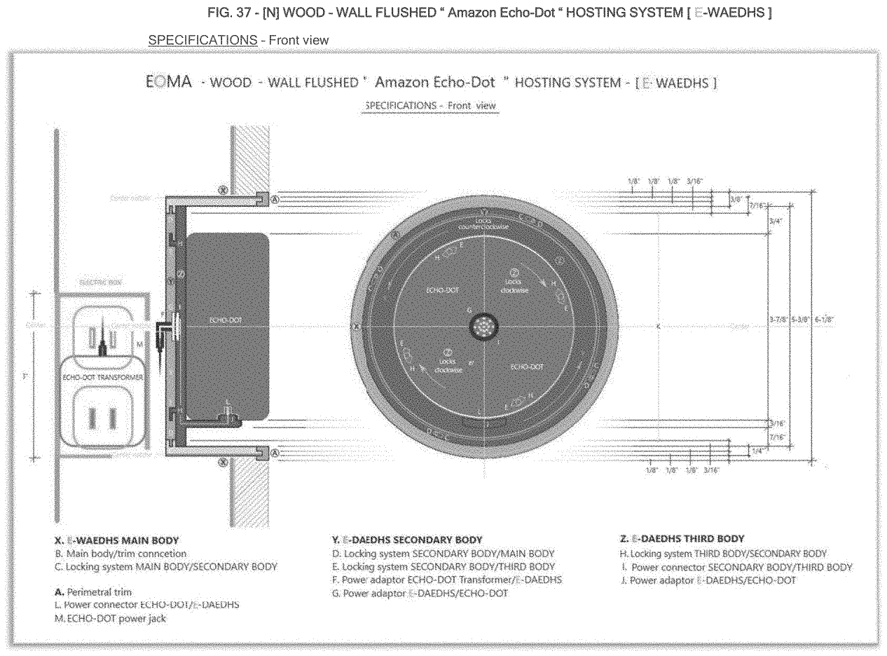

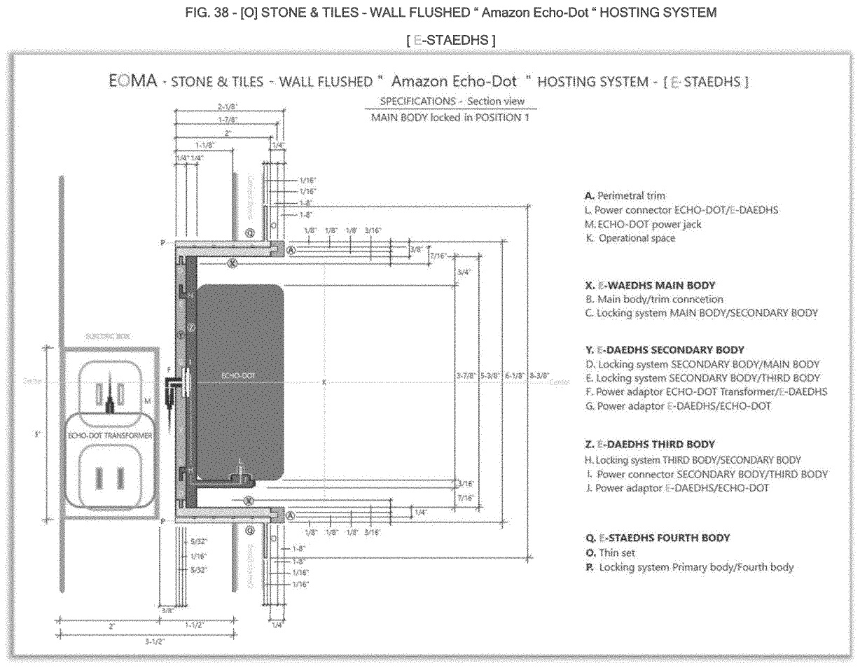

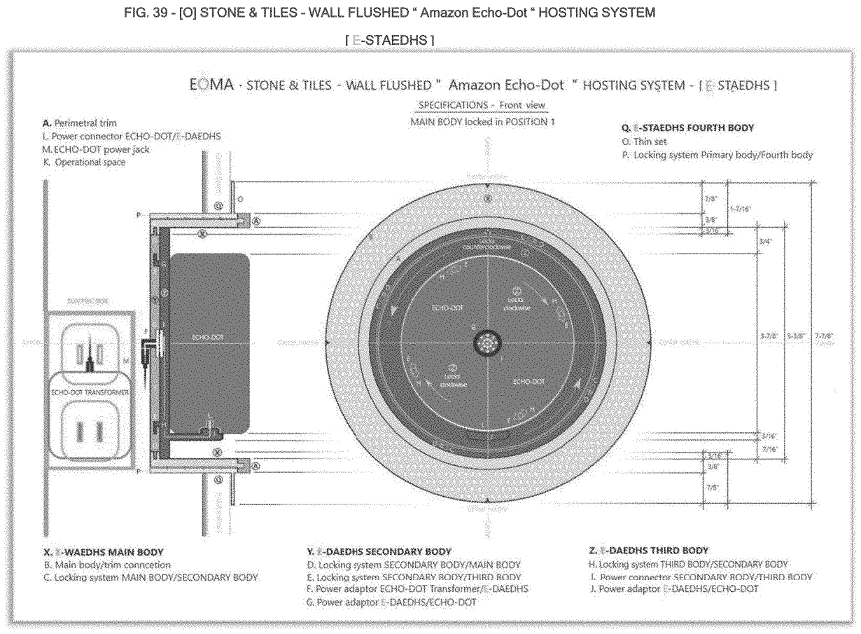

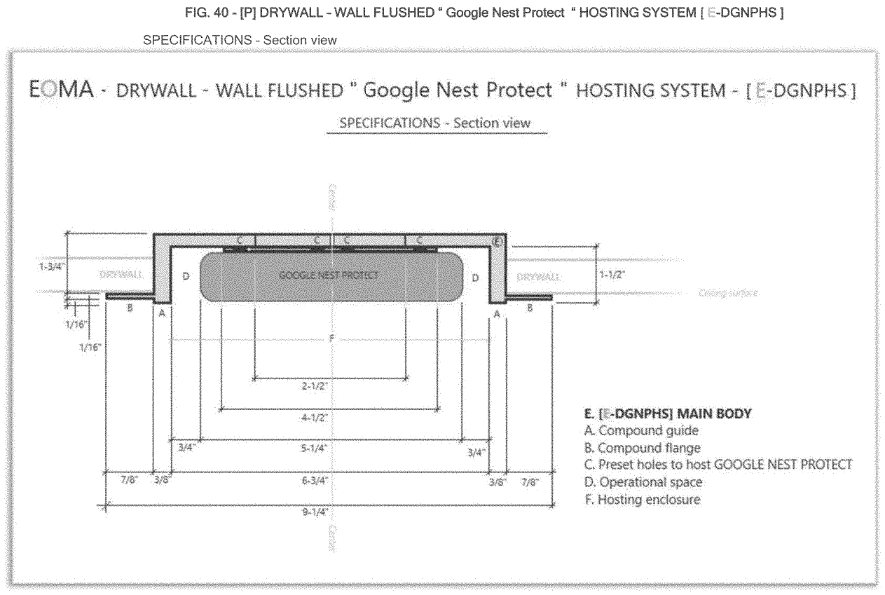

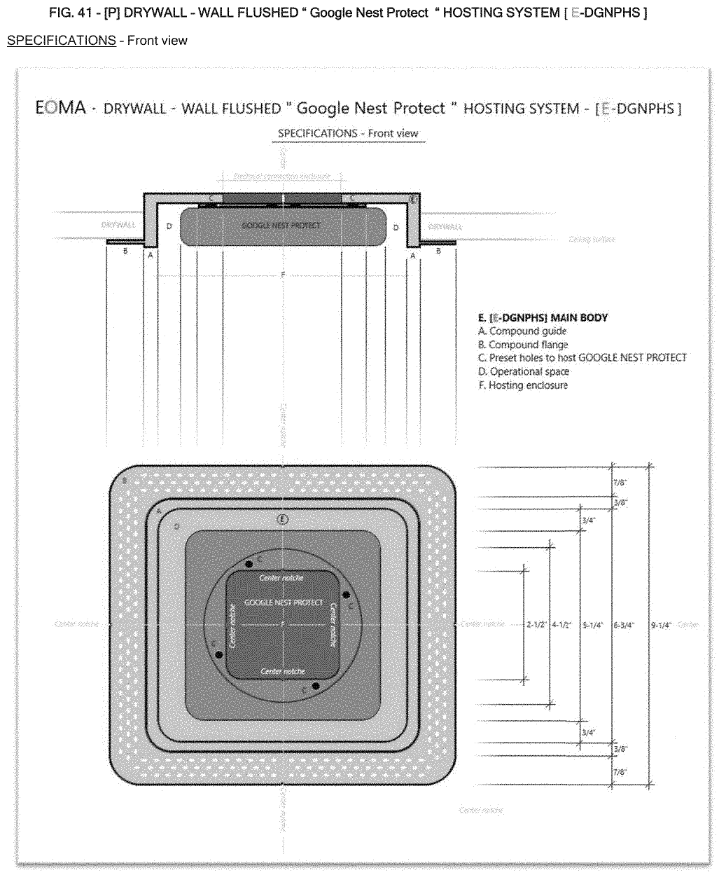

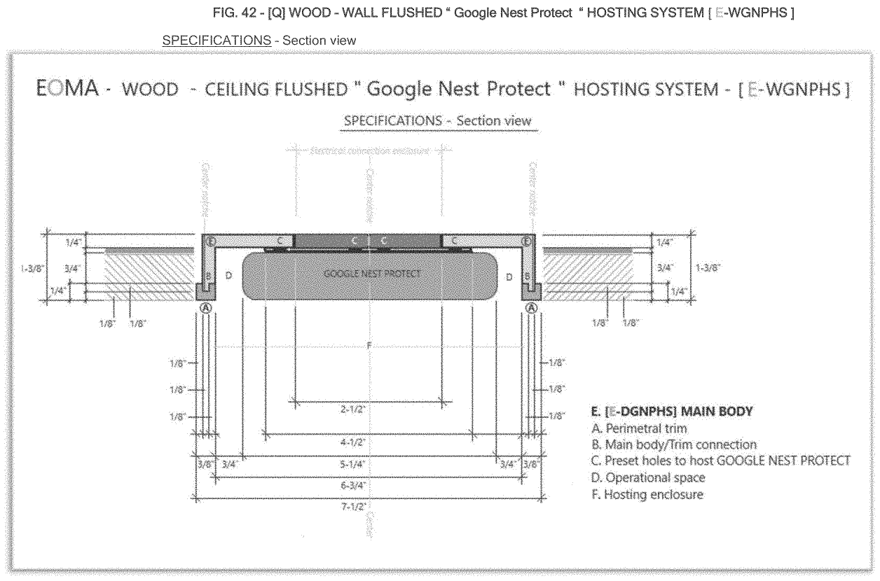

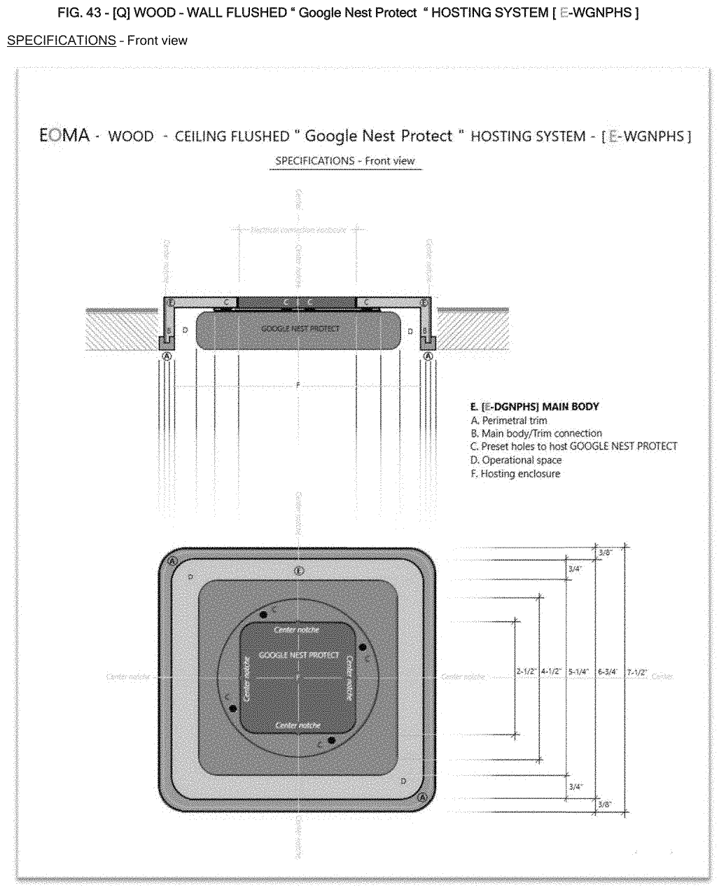

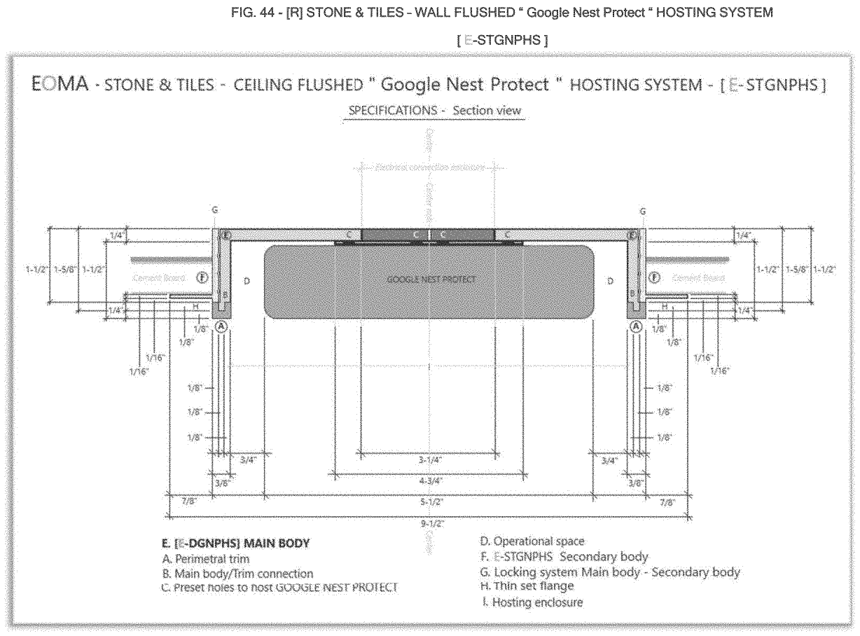

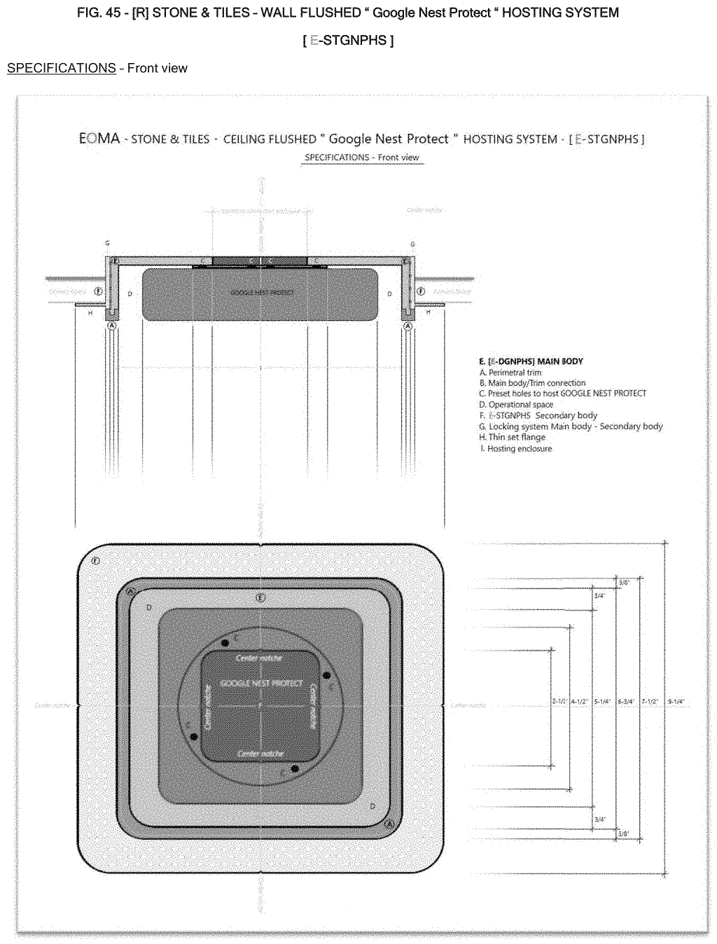

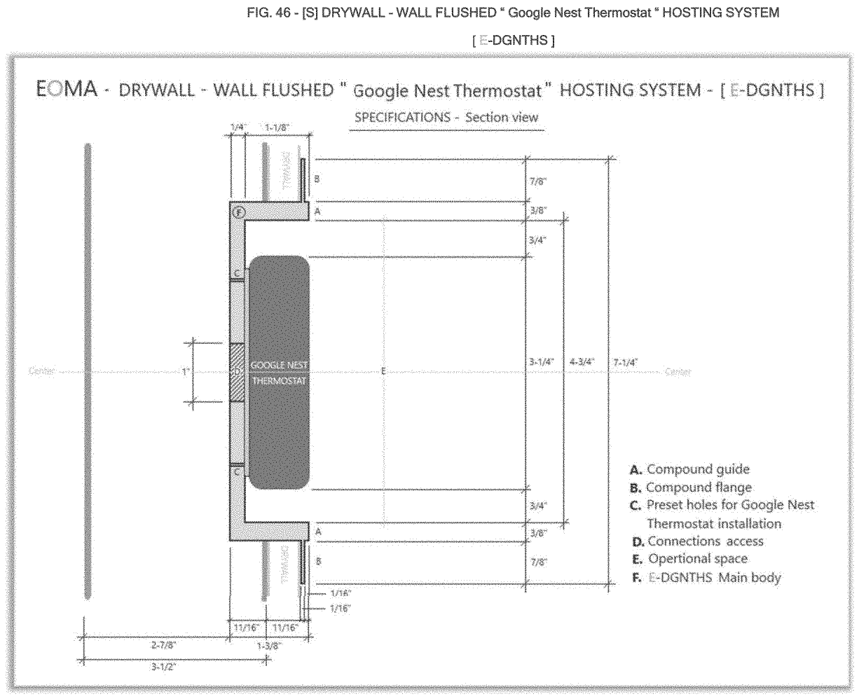

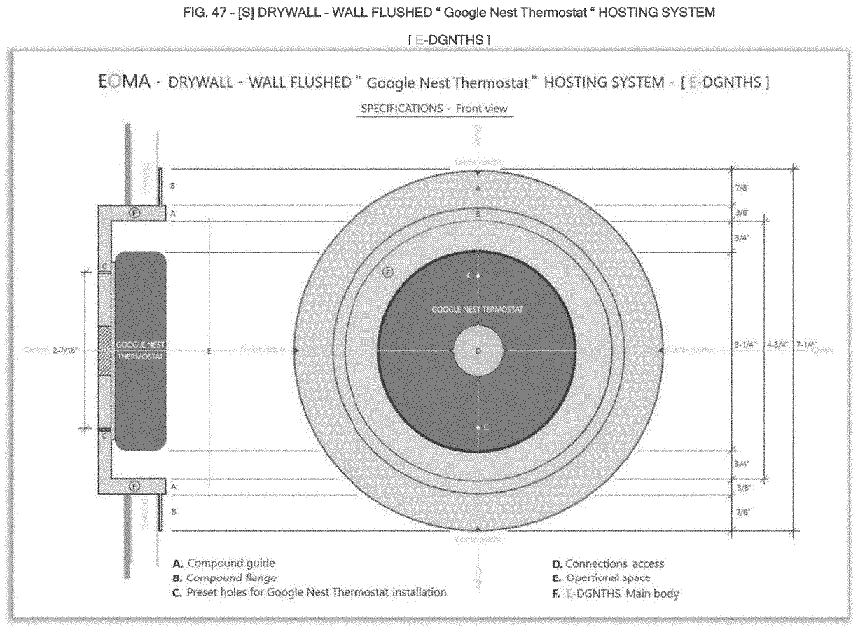

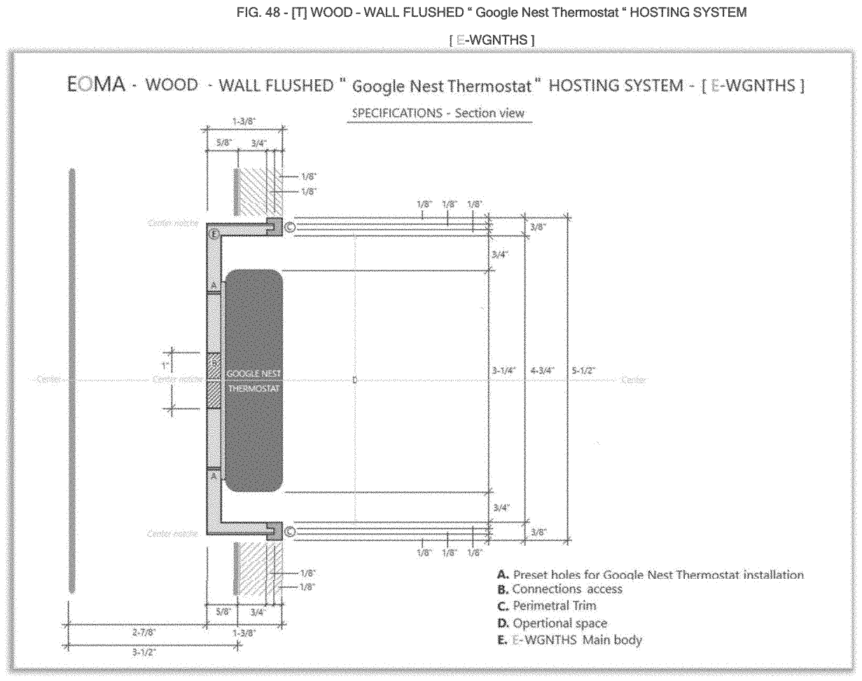

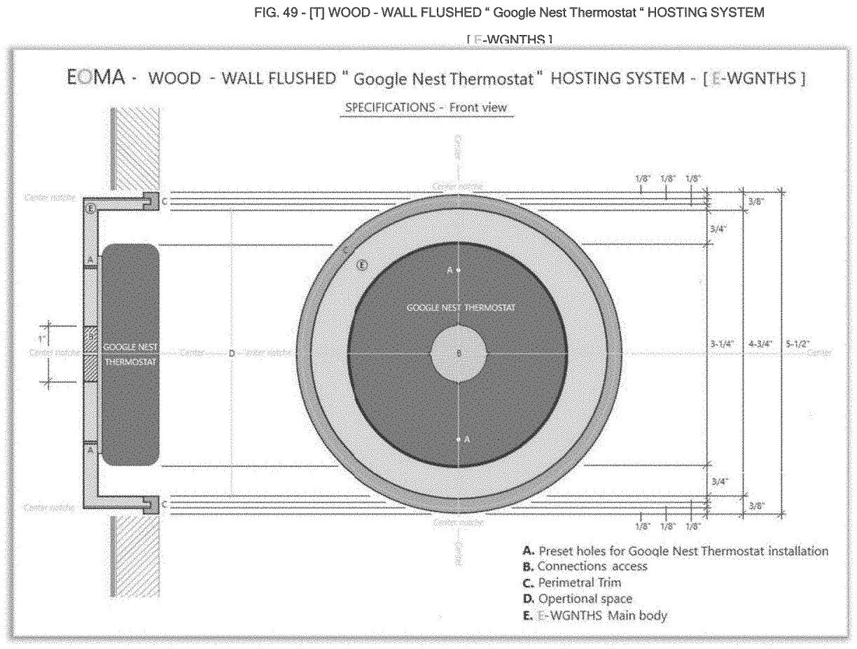

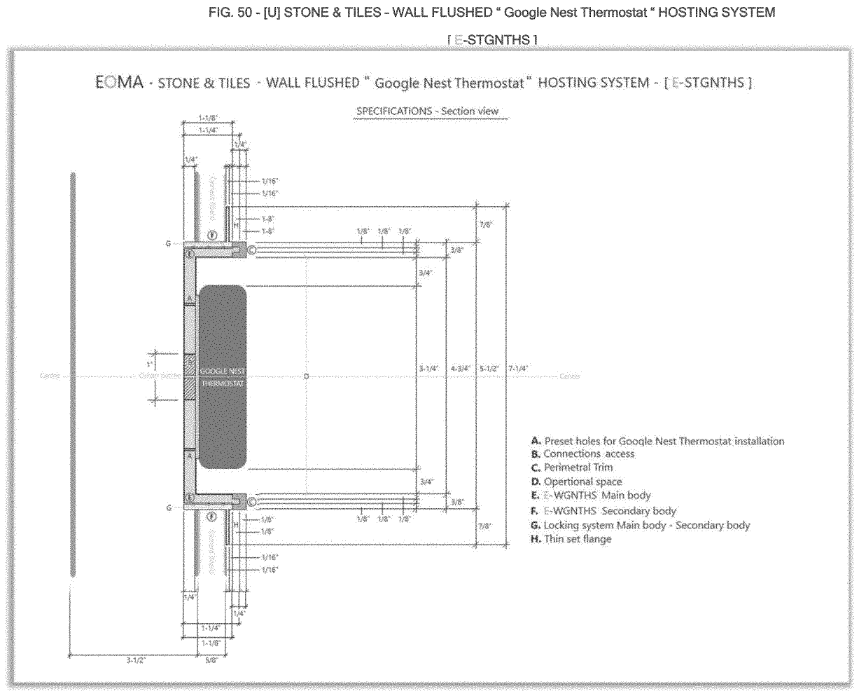

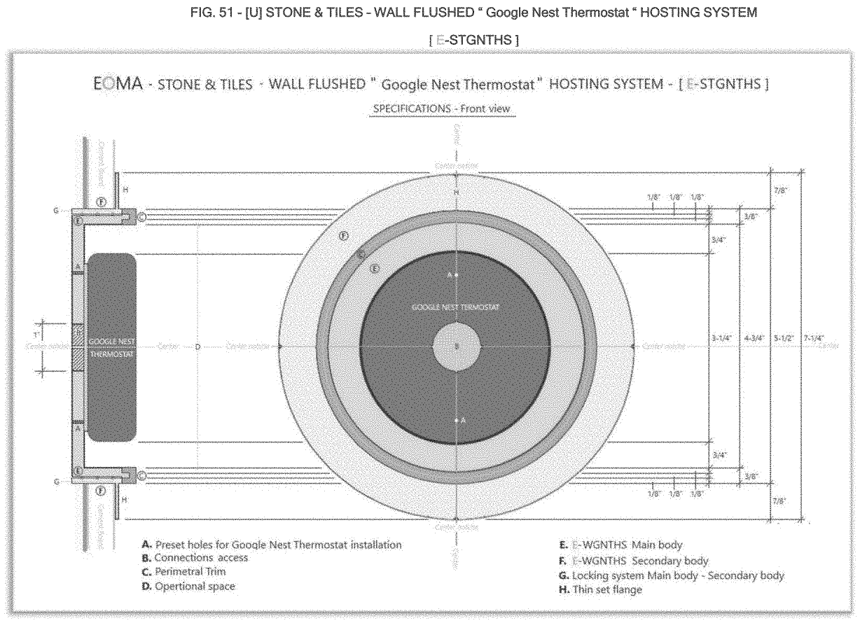

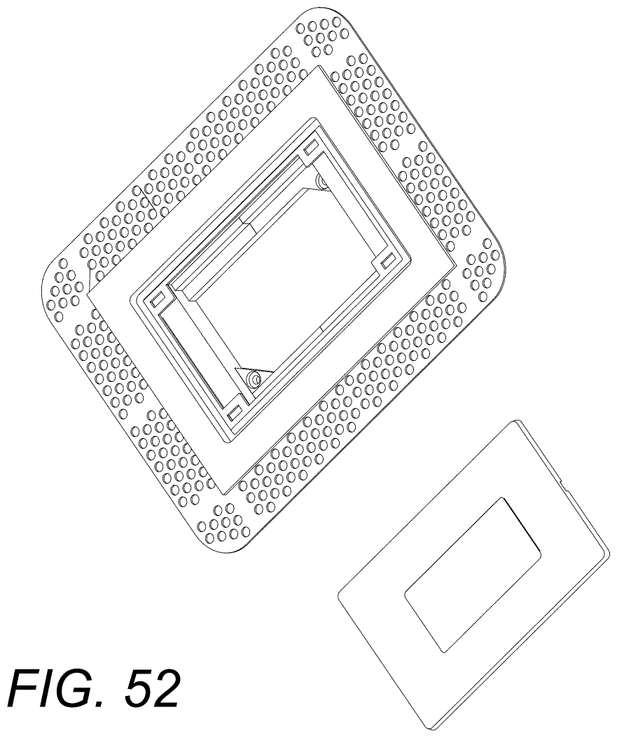

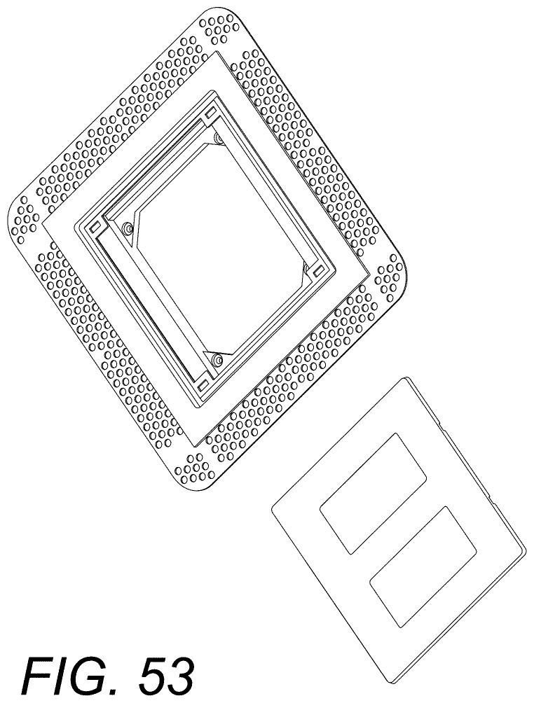

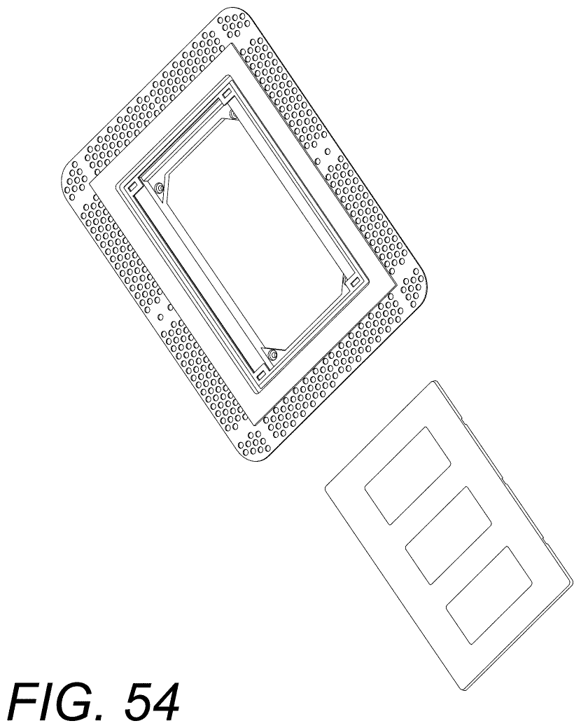

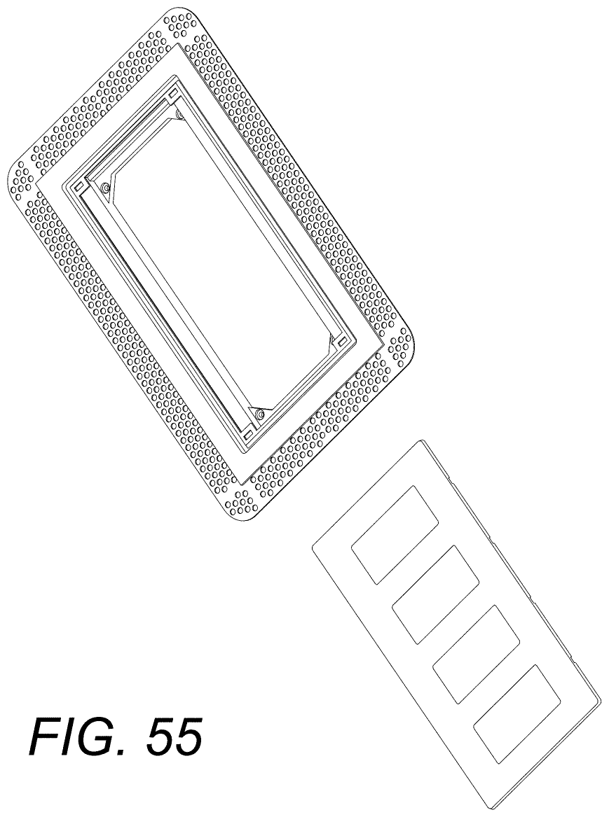

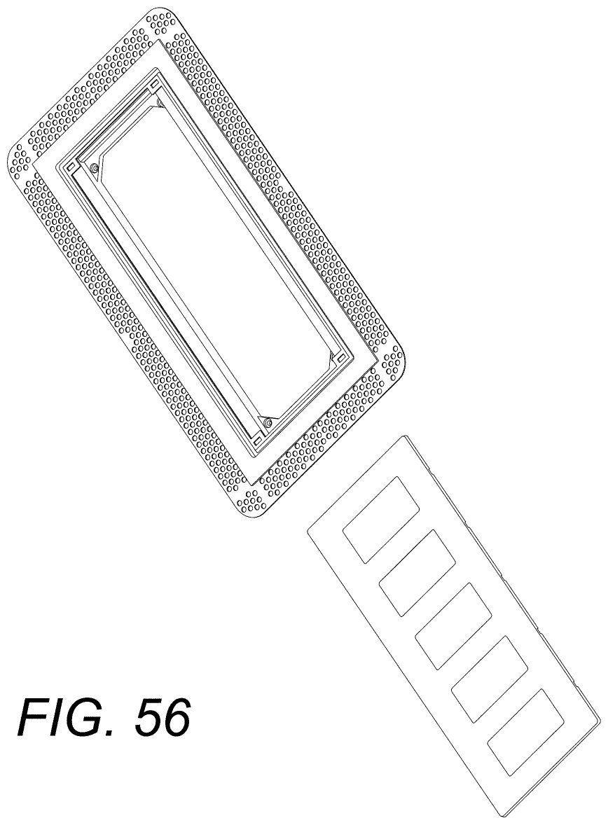

### DETAILED DESCRIPTION OF THE PREFERRED EMBODIMENTS

### Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology will include the words specifically mentioned, derivatives thereof and words of similar meaning.

### II. Preferred Embodiments

The present invention discloses an electrical cover apparatus and a method of use. The electrical cover apparatus is configured for universally retrofitting standard electrical components with a sleek, design-oriented, flush installation that results in the electrical cover becoming a part of the overall architectural design rather than an obstruction.

In an exemplary embodiment of the present invention, the electrical cover apparatus includes a series of customizable features for use with various electrical components and for use with various adjacent architectural surfaces. The apparatus is further configured for easy installation and convenient and efficient user access to the electrical components housed within, as necessary. Embodiments of the electrical cover apparatus are configured for installation onto different surface materials, including but not limited to drywall, wood, stone, and tile, without changing conventional and standard construction processes and methods thereof.

The electrical cover apparatus of the present invention includes a main body configured for housing and retrofitting most standard modern electrical switches, outlets, receptacles, smart switches, and other related accessories for installation onto standard universal wall plate openings for a flush application to adjacent surfaces. Additional embodiments of the electrical cover apparatus are configured for a mounting, housing, and/or covering all or a portion of smart home Internet of Things (IoT) devices. Such smart home IoT device configurations include, but are not limited to, cover assemblies for smart thermostats, electrical switches, smoke detectors, carbon monoxide detectors, alarm systems, doorbells, cameras, motion detectors, and speakers. Such IoT devices may be integrated with Google Nest, Amazon Alexa, Orro, Apple HomeKit, or any alternative type of IoT technology.

In an exemplary embodiment, the electronic cover apparatus includes a main body having a substantially hollow interior; a series of connection holes, notches, and grooves; a locking mechanism, and an outer lip. The substantially hollow interior is configured for housing electrical components and for accommodating retrofitting of the cover apparatus to conventional electric switches, outlets receptacles, smart switches, and many other related accessories installed onto a universal wall plate opening. In a preferred embodiment of the present invention, the cover apparatus is configured to accommodate the highest level of heat dispersion common with most hosted electrical components and devices, such as but not limited to dimmers and smart IoT devices.

The main body outer lip is configured for laying over an adjacent application surface with the cover apparatus in an assembled position. With the cover apparatus in an assembled position on the application surface, drywall finishing compound, plaster, spackle, or an alternative binding material is applied over the outer lip for flush attachment of the cover apparatus to the application surface. In a preferred embodiment of the present invention, the outer lip is thin and includes some flexibility. However, in alternative embodiments, the outer lip may be rigid. Preferably, the outer lip of the present invention also includes a series of holes or perforations configured for better adherence of the cover apparatus to the application surface. Such an outer lip allows for smooth, flush transition to the adjacent surface.

In an exemplary embodiment, the main body locking mechanism is configured for locking the cover apparatus to the back side of the application surface, such as a wall. The locking mechanism can be toggled between an unlocked position and a locked position by a user reaching through the main body substantially hollow interior to the back of the main body and the back side of the application surface. In embodiments, the locking mechanism may be rotated or slid between locked and unlocked position. The main body may include further include additional locking positions for use with alternative sizes of application surface openings. When locked, the locking mechanism is configured to hold the electrical cover apparatus in place relative to the application surface. In an exemplary embodiment, the main body also includes mounting holes on the side of the main body opposite the locking mechanism for further secure attachment of the electrical cover apparatus to the application surface via fasteners.

In an exemplary embodiment of the present invention, the electrical cover apparatus main body includes a fitting system with multiple groove positions. The fitting system accommodates adjustment and adaptation of the cover apparatus to a desired level to which the electrical components or product hosted is set and secured onto the main body. This fitting system allows for a secure fit and ensures a final flushed result. The electrical cover apparatus is configured with a series of spacers and outer finishing plates for use with various electric components and devices.

In a preferred embodiment, the electrical cover apparatus further includes an access system for convenient and efficient access to the electrical components housed within the apparatus. The outer plate includes a perimetral groove configured for easy removal of the plate to perform all electrical connections or settings of the specific product hosted by the apparatus. In an exemplary embodiment the access system groove is U-shaped and further includes a corresponding tool configured for fitting within the groove for easy removal of the plate. However, alternative shapes may be utilized in other embodiment of the present invention.

In an exemplary embodiment, the present invention may further include a finish guard that ergonomically clips onto the cover apparatus U-shaped groove, allowing for easy and safe finish operations without compromising the integrity of the system. In further embodiments, other features may attach to the U-shaped groove, as desired, such as, but not limited to, LED lights.

Embodiments of the present invention are scalable, with electrical cover apparatuses with outer plates having any number of electrical component openings, as desired. The outer plates may further be any color configured to match the adjacent surface or to stand out, if desired. Additionally, any shape of electrical cover apparatus may be utilized embodying the present invention.

Without limitation on the generality of useful applications of the present invention, the cover apparatus can be installed in interior walls, ceilings and floors comprising various construction materials, e.g., sheet rock (gypsum board), paneling, tile, stone, etc. Moreover, various components can be accommodated, including electrical (e.g., switches, outlets, thermostats, etc.), HVAC, security devices, etc. Still further, various finish systems (e.g., paint, wallcovering, etc.) can be utilized for achieving design objectives, such as aesthetics, environmental-friendliness, economy and durability.

### III. Conclusion

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A flush-mount cover apparatus for an electrical component mounted in a wall with a wall surface, which apparatus includes:
a main body with a hollow interior configured for receiving the electrical component in a mounted position generally flush with and accessible from the wall surface;
the main body including and outer lip configured for overlying and adjacent portion of the wall surface;
multiple perforations in said outer lip;
a main body locking mechanism configured for releasably locking the main body in the wall with the outer lip flush with the wall surface;
a fitting system with multiple group positions configured for adjusting and adapting the cover apparatus to a desired level flush with the wall surface;
an access system including an outer plate with a U-shaped perimeter groove configured for removably attaching the outer plate to the main body; and
a finish guard configured for clipping into the cover apparatus U-shaped groove.
